(19) United States
(12) Patent Application Publication
(10) Pub. No.: US 2026/0106367 A1
(43) Pub. Date: Apr. 16, 2026

(54) MULTI-FOLDABLE ELECTRONIC DEVICE INCLUDING ANTENNA

(71) Applicant: Samsung Electronics Co., Ltd., Suwon-si (KR)

(72) Inventors: Kyungil SEO, Suwon-si (KR); Kyoungmok KIM, Suwon-si (KR); Jiho KIM, Suwon-si (KR); Haeyeon KIM, Suwon-si (KR); Hojung NAM, Suwon-si (KR); Kyungmoon SEOL, Suwon-si (KR); Kyihyun JANG, Suwon-si (KR); Huiwon CHO, Suwon-si (KR); Soonho HWANG, Suwon-si (KR)

(21) Appl. No.: 19/283,860

(22) Filed: Jul. 29, 2025

Related U.S. Application Data
(63) Continuation of application No. PCT/KR2025/009906, filed on Jul. 8, 2025.

(30) Foreign Application Priority Data
Oct. 15, 2024 (KR) 10-2024-0140774
Mar. 24, 2025 (KR) 10-2025-0037587

(51) Int. Cl. H01Q 1/24; H01Q 1/38; H04M 1/02

(52) U.S. Cl. CPC H01Q 1/243; H01Q 1/38; H04M 1/0216

(57) ABSTRACT

An electronic device is provided. The electronic device includes a foldable housing including a first housing part, a second housing part, and a third housing part, wherein the first housing part includes a first conductive portion configured to operate as an antenna radiator of the electronic device, and a second conductive portion spaced apart from the first conductive portion, wherein the second housing part includes a third conductive portion, and a fourth conductive portion spaced apart from the third conductive portion, wherein in a state in which a foldable housing is folded, the first conductive portion of the first housing part at least partially faces the third conductive portion of the second housing part, wherein the electronic device includes switching circuitry electrically connected to the third conductive portion and the fourth conductive portion of the second housing part, wherein, while the first conductive portion of the first housing part operates as the antenna radiator in the folded state, the switching circuitry is configured to filter a signal having a frequency corresponding to an operating frequency of the antenna radiator.

### CROSS-REFERENCE TO RELATED APPLICATION(S)

This application is a continuation application, claiming priority under 35 U.S.C. § 365(c), of an International application No. PCT/KR2025/009906, filed on Jul. 8, 2025, which is based on and claims the benefit of a Korean patent application number 10-2024-0140774, filed on Oct. 15, 2024, in the Korean Intellectual Property Office, and of a Korean patent application number 10-2025-0037587, filed on Mar. 24, 2025, in the Korean Intellectual Property Office, the disclosure of each of which is incorporated by reference herein in its entirety.

### TECHNICAL FIELD

The disclosure relates to a foldable electronic device including an antenna.

### BACKGROUND ART

A multi-foldable electronic device may include a foldable housing. The foldable housing may include a plurality of housing parts that are foldable with respect to each other. For example, the foldable housing of the multi-foldable electronic device may include a first housing part, a second housing part rotatably coupled to the first housing part, and a third housing part rotatably coupled to the second housing part.

Conductive portions of the foldable housing forming an exterior of the multi-foldable electronic device may be used as an antenna radiator of the multi-foldable electronic device.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a foldable electronic device including an antenna.

Additional aspects will be set forth in part in the description which follows and, in part, will be apparent from the description, or may be learned by practice of the presented embodiments.

In accordance with an aspect of the disclosure, an electronic device is provided. The electronic device includes a foldable housing including a first housing part, a second housing part, and a third housing part, wherein each of the first housing part, the second housing part, and the third housing part is rotatably coupled to an adjacent housing part among the first housing part, the second housing part, and the third housing part so as to allow the foldable housing to transition between a folded state and an unfolded state, wherein, in the unfolded state, the first housing part, the second housing part, and the third housing part are positioned on substantially the same plane, wherein, in the folded state, the second housing part is positioned on the first housing part, wherein, in the folded state, the third housing part is positioned on the second housing part, wherein the first housing part includes a first conductive portion configured to operate as an antenna radiator of the electronic device, a second conductive portion spaced apart from the first conductive portion, and a first non-conductive portion disposed between the first conductive portion and the second conductive portion, wherein the second housing part includes a third conductive portion, a fourth conductive portion spaced apart from the third conductive portion, and a second non-conductive portion disposed between the third conductive portion and the fourth conductive portion, wherein, in the folded state, the first conductive portion of the first housing part at least partially faces the third conductive portion of the second housing part, wherein the electronic device includes switching circuitry electrically connected to the third conductive portion and the fourth conductive portion of the second housing part, and wherein, while the first conductive portion of the first housing part operates as the antenna radiator in the folded state, the switching circuitry is configured to filter a signal having a frequency corresponding to an operating frequency of the antenna radiator.

In accordance with another aspect of the disclosure, a foldable electronic device is provided. The foldable electronic device includes a first housing part, a second housing part, and a third housing part, wherein the first housing part is rotatably coupled to a first side of the third housing part and the second housing part is rotatably coupled to a second side of the third housing part, wherein, in an unfolded state of an electronic device, the first housing part, the second housing part, and the third housing part are positioned on substantially the same plane, wherein, in a folded state of the electronic device, the second housing part is positioned on the first housing part, and the third housing part is positioned on the second housing part, wherein the first housing part includes a first conductive portion configured to operate as an antenna radiator of the electronic device, a second conductive portion spaced apart from the first conductive portion, and a first non-conductive portion disposed between the first conductive portion and the second conductive portion, wherein the second housing part includes a third conductive portion, a fourth conductive portion spaced apart from the third conductive portion, and a second non-conductive portion disposed between the third conductive portion and the fourth conductive portion, wherein, in the folded state, the first conductive portion of the first housing part at least partially faces the second conductive portion of the second housing part, wherein the foldable electronic device includes switching circuitry electrically connected to the third conductive portion and the fourth conductive portion of the second housing part, and wherein, while the first conductive portion of the first housing part operates as the antenna radiator in the folded state, the switching circuitry may be configured to filter a signal having a frequency corresponding to an operating frequency of the antenna radiator.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A illustrates a first state of an electronic device according to an embodiment of the disclosure;

FIG. 2B illustrates a second state of an electronic device according to an embodiment of the disclosure;

FIG. 2C illustrates a third state of an electronic device according to an embodiment of the disclosure;

FIG. 3A is a plan view of an electronic device with a flexible display removed according to an embodiment of the disclosure;

FIG. 3B is a rear view of an electronic device with a rear cover and a display removed according to an embodiment of the disclosure;

FIG. 4A indicates an electronic device in a multi-folded state according to an embodiment of the disclosure;

FIG. 4B indicates a current flow of an electronic device in a multi-folded state when an antenna operates according to an embodiment of the disclosure;

FIG. 4C is a graph indicating radiation efficiency of an electronic device in a multi-folded state and an unfolded state according to an embodiment of the disclosure;

FIGS. 5A and 5B indicates a folded state of an electronic device according to a comparative example according to various embodiments of the disclosure;

FIG. 6 is a diagram indicating an electronic device according to an embodiment of the disclosure;

FIG. 7A indicates an electronic device in an unfolded state according to an embodiment of the disclosure;

FIG. 7B indicates housing parts of an electronic device in a multi-folded state according to an embodiment of the disclosure;

FIGS. 7C and 7D indicate an electronic device in a multi-folded state according to various embodiments of the disclosure;

FIG. 7E indicates a third housing part in which switching circuits are disposed, according to an embodiment of the disclosure;

FIG. 8A indicates an electronic device in a multi-folded state according to an embodiment of the disclosure;

FIG. 8B indicates a current flow of an electronic device according to a comparative example and a current flow of an electronic device according to an embodiment when a first antenna operates according to an embodiment of the disclosure;

FIG. 8C indicates radiation efficiency of a first antenna of an electronic device according to a comparative example and radiation efficiency of a first antenna of an electronic device according to a comparative example according to an embodiment of the disclosure;

FIG. 9A indicates an electronic device in a multi-folded state according to an embodiment of the disclosure;

FIG. 9B indicates a current flow of an electronic device according to a comparative example and a current flow of an electronic device according to an embodiment when a fifth antenna operates according to an embodiment of the disclosure;

FIG. 9C indicates radiation efficiency of a fifth antenna of an electronic device according to a comparative example and radiation efficiency of a fifth antenna of an electronic device according to a comparative example according to an embodiment of the disclosure;

FIG. 10A indicates an electronic device in a multi-folded state according to an embodiment of the disclosure;

FIG. 10B indicates a current flow of an electronic device according to a comparative example and a current flow of an electronic device according to an embodiment when a third antenna operates according to an embodiment of the disclosure;

FIG. 10C indicates radiation efficiency of a third antenna of an electronic device according to a comparative example and radiation efficiency of a third antenna of an electronic device according to a comparative example according to an embodiment of the disclosure;

FIG. 10D indicates radiation efficiency of a sixth antenna of an electronic device according to a comparative example and radiation efficiency of a sixth antenna of an electronic device according to a comparative example according to an embodiment of the disclosure;

FIG. 11A indicates an electronic device in a multi-folded state according to an embodiment of the disclosure;

FIG. 11B indicates radiation efficiency of a second antenna of an electronic device according to a comparative example and radiation efficiency of a second antenna of an electronic device according to a comparative example according to an embodiment of the disclosure;

FIG. 12A indicates an electronic device in a multi-folded state according to an embodiment of the disclosure;

FIG. 12B indicates a power flow during operation of a third antenna of an electronic device according to a comparative example and a power flow during operation of a third antenna of an electronic device according to an embodiment of the disclosure;

FIG. 12C is a graph indicating radiation efficiency of a third antenna of an electronic device according to a comparative example and radiation efficiency of a third antenna of an electronic device according to an embodiment of the disclosure;

FIG. 13A indicates an electronic device in a multi-folded state according to an embodiment of the disclosure;

FIG. 13B indicates a current flow during operation of a first antenna of an electronic device according to a comparative example and a current flow during operation of a first antenna of an electronic device according to an embodiment of the disclosure;

FIG. 13C indicates radiation efficiency of a first antenna of an electronic device according to a comparative example and radiation efficiency of a first antenna of an electronic device according to an embodiment of the disclosure;

FIG. 14A indicates an electronic device in a multi-folded state according to an embodiment of the disclosure;

FIG. 14B indicates a current flow during operation of a third antenna of an electronic device according to a comparative example and a current flow during operation of a third antenna of an electronic device according to an embodiment of the disclosure;

FIG. 14C indicates radiation efficiency of a third antenna of an electronic device according to a comparative example and radiation efficiency of a third antenna of an electronic device according to an embodiment of the disclosure; and

FIG. 14D indicates radiation efficiency of a sixth antenna of an electronic device according to a comparative example and radiation efficiency of a sixth antenna of an electronic device according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

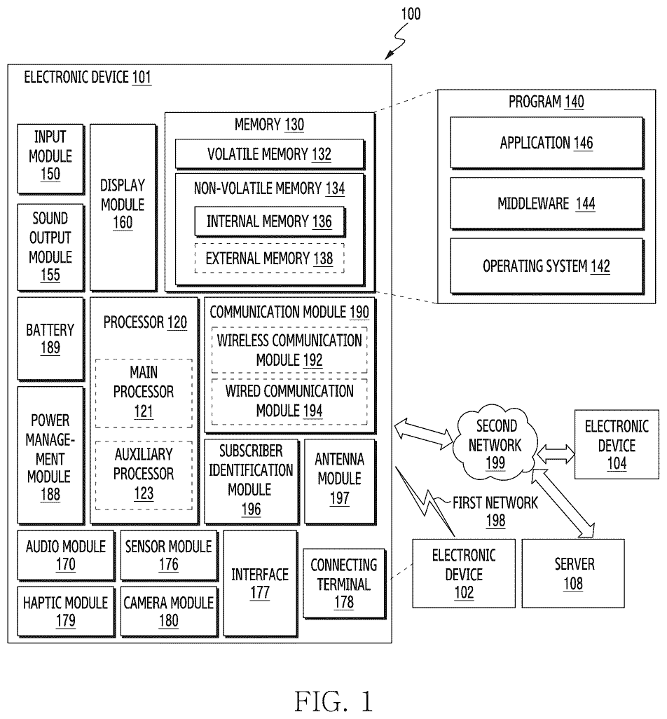

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beamforming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

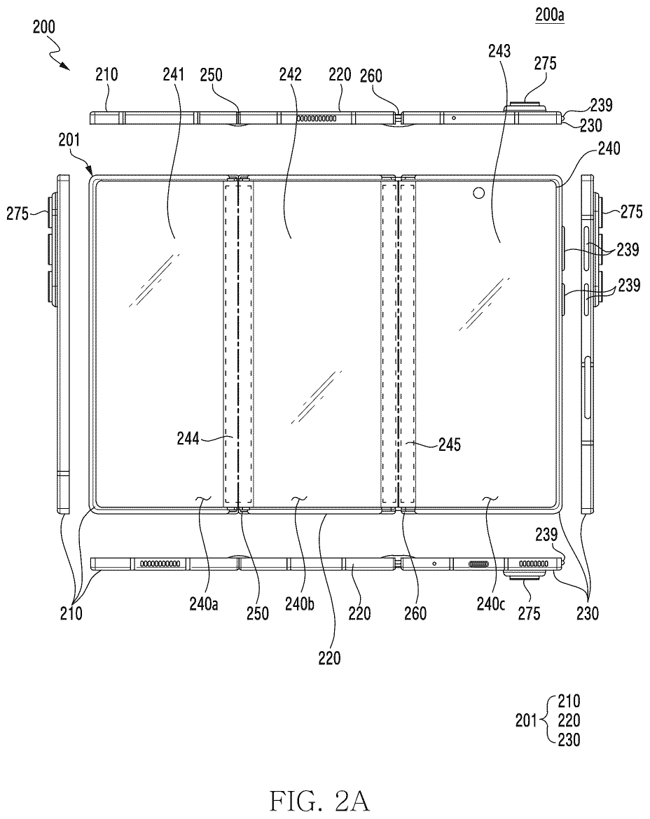

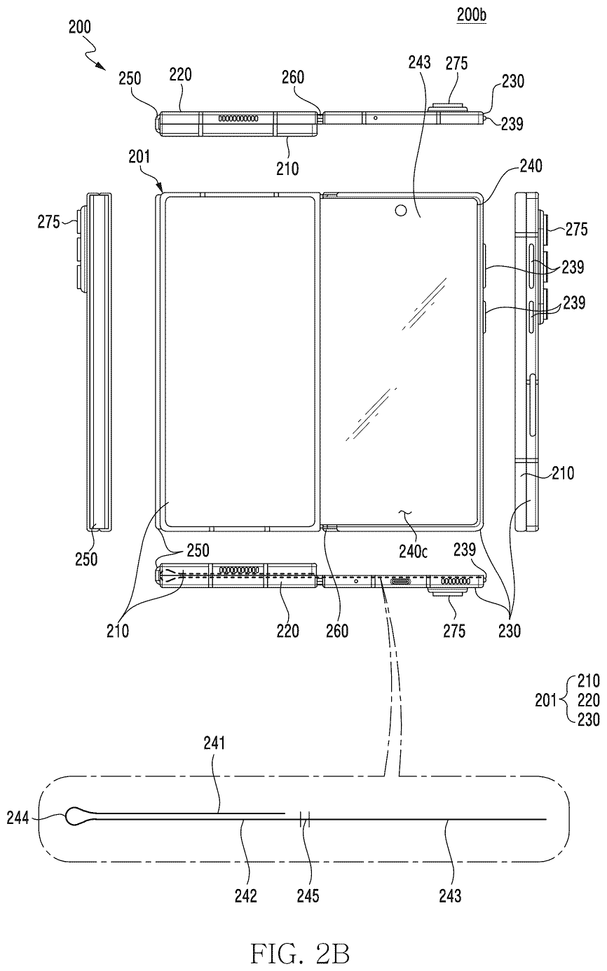

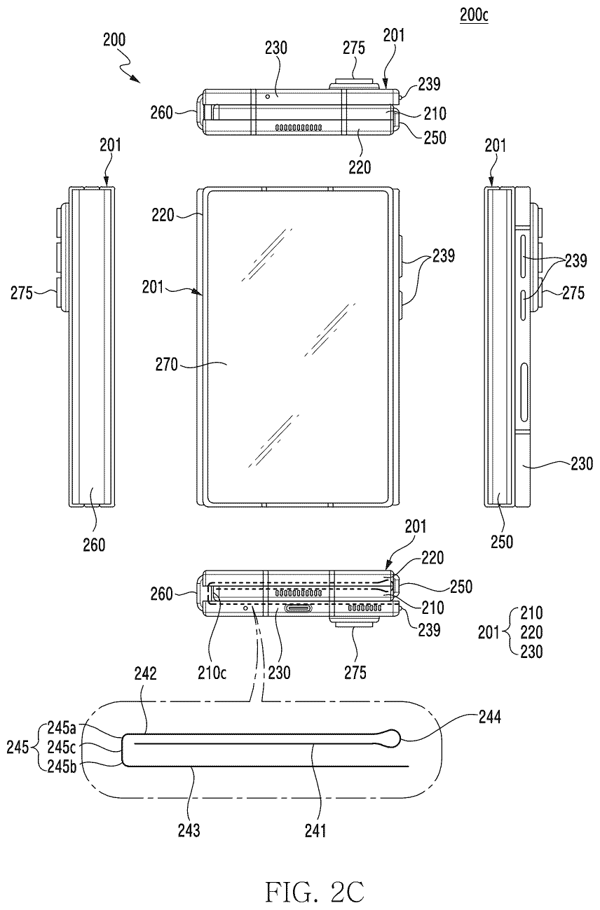

FIG. 2A illustrates a first state of an electronic device according to an embodiment of the disclosure. FIG. 2B illustrates a second state of an electronic device according to an embodiment of the disclosure. FIG. 2C illustrates a third state of an electronic device according to an embodiment of the disclosure.

Referring to FIGS. 2A, 2B, and 2C, an electronic device 200 (e.g., the electronic device 101) may include a housing structure 201, a flexible display 240, a first hinge structure 250, a second hinge structure 260, and a display 270 (e.g., the display module 160). The first housing structure 201 may include a first housing part 210, a second housing part 220, and a third housing part 230.

The first housing part 210 may be rotatably coupled to the second housing part 220 by the first hinge structure 250. The second housing part 220 and the first housing part 210 may be rotated with respect to the first hinge structure 250. While the first housing part 210 rotates with respect to the first hinge structure 250, the second housing part 220 may rotate with respect to the first hinge structure 250. For example, when the second housing part 220 and the first housing part 210 are rotated with respect to the first hinge structure 250, an angular displacement of the second housing part 220 may be substantially equal to an angular displacement of the first housing part 210.

The third housing part 230 may be rotatably coupled to the second housing part 220 by the second hinge structure 260. The second housing part 220 and the third housing part 230 may be rotated with respect to the second hinge structure 260. While the second housing part 220 is rotated with respect to the second hinge structure 260, the third housing part 230 may be rotated with respect to the second hinge structure 260. For example, when the second housing part 220 and the third housing part 230 are rotated with respect to the second hinge structure 260, the angular displacement (or angular change) of the second housing part 220 may be substantially equal to the angular displacement of the third housing part 230.

The first hinge structure 250 and the second hinge structure 260 may change a state of the electronic device. The first hinge structure 250 and the second hinge structure 260 may provide (or enable) a first state 200a of the electronic device 200 (or a first state 200a of the housing structure 201). The first state 200a of the electronic device 200 (or the first state 200a of the housing structure 201) may be described as an unfolded state (or unfolding state) of the electronic device 200 (or the housing structure 201). In the first state 200a, a front surface of the first housing part 210, a front surface of the second housing part 220, and a front surface of the third housing part 230 may define a front surface of the electronic device 200. In the first state 200a, the front surface of the first housing part 210, the front surface of the second housing part 220, and the front surface of the third housing part 230 may face the same direction. In the first state 200a, the electronic device 200 may provide a large display region of the flexible display 240 to the user.

The first hinge structure 250 and the second hinge structure 260 may provide a second state 200b of the electronic device 200. The second state 200b of the electronic device 200 may be described as a state in which the electronic device 200 is partially folded and partially unfolded (or a single folding state or a half folding state). For example, in the second state 200b, the front surface of the second housing part 220 and the front surface of the third housing part 230 may face the same direction, and the front surface of the first housing part 210 and the front surface of the second housing part 220 may face opposite directions. For example, in the second state 200b, the first housing part 210 and the second housing part 220 may be folded, and the second housing part 220 and the third housing part 230 may be unfolded. In the second state 200b, the electronic device 200 may provide visual information through a portion (e.g., a third display region 240c) of the flexible display 240.

The electronic device 200 may change from the first state 200a to the third state 200c through the second state 200b. The electronic device 200 may change from the first state 200a, which is an unfolded state, to the second state 200b, which is a partially unfolded state. For example, the electronic device 200 may change from the first state 200a in which the first housing part 210, the second housing part 220, and the third housing part 230 face the same direction, to the second state 200b in which the front surface of the first housing part 210 faces the front surface of the second housing part 220. The electronic device 200 may change from the second state 200b, which is partially unfolded, to the third state 200c, which is folded. For example, when changing from the second state 200b to the third state 200c, the folded first housing part 210 and the second housing part 220 may be disposed on the third housing part 230.

The first hinge structure 250 and the second hinge structure 260 may provide a third state 200c of the electronic device 200 (or a third state 200c of the housing structure 201). The third state 200c of the electronic device 200 (or the third state 200c of the housing structure 201) may be described as a state in which the electronic device 200 (or the housing structure 201) is folded (or a folding state or a multi-folding state). In the third state 200c, the front surface of the first housing part 210 and the front surface of the second housing part 220 may face opposite directions, and the front surface of the second housing part 220 and the front surface of the third housing part 230 may face opposite directions. In the third state 200c, the front surface of the first housing part 210 and the front surface of the third housing part 230 may face the same direction. For example, in the third state 200c, the front surface of the second housing part 220 may face the front surface of the first housing part 210, and the front surface of the third housing part 230 may face a rear surface of the first housing part 210. In the third state 200c, a rear surface of the second housing part 220 may be exposed to the outside. The display 270 may be disposed on the rear surface of the second housing part 220. In the third state 200c, a rear surface of the third housing part 230 may be exposed to the outside. A camera 275 may be disposed on the rear surface of the third housing part 230. In the third state 200c, the electronic device 200 may be folded to enhance portability and may provide visual information through the display 270 disposed on the rear surface of the second housing part 220.

The electronic device 200 may further include a key button 239. The key button 239 may be exposed from a structure (e.g., opening) formed on a side surface of the third housing part 230 and may partially protrude to the outside of the electronic device 200. The key button 239 may provide a physical input to processing circuitry inside the electronic device 200 by a pressure transmitted from the outside. The key button 239 may not be included in the electronic device 200 and may be implemented in another form, such as a soft key displayed on the flexible display 240 or the display 270.

The key button 239 may be disposed on the side surface of the third housing part 230 so as to be exposed to the outside in the third state 200c. The key button 239 may be disposed in a direction toward which the side surface of the third housing part 230 faces by being disposed on the side surface of the third housing part 230. Even when the third state 200c is changed to the first state 200a by a user looking at the display 270, a position of the key button 239 disposed on the side surface of the third housing part 230 may not move. For example, referring to FIG. 2A, in the first state 200a, when the flexible display 240 is viewed from above, the key button 239 may be disposed on the right. Referring to FIG. 2B, in the third state 200c, when the display 270 is viewed from above, the key button 239 may be disposed on the right side.

The flexible display 240 may at least partially define a surface of the electronic device 200. The flexible display 240 may be partially disposed within the housing structure 201. The flexible display 240 may define a front surface of the electronic device 200. The flexible display 240 may include a first unbendable portion 241, a second unbendable portion 242, a third unbendable portion 243, a first bendable portion 244, and a second bendable portion 245. The first unbendable portion 241 of the flexible display 240 may be disposed on the front surface of the first housing part 210. The second unbendable portion 242 of the flexible display 240 may be disposed on the front surface of the second housing part 220. The third unbendable portion 243 of the flexible display 240 may be disposed on the front surface of the third housing part 230. The first bendable portion 244 of the flexible display 240 may be disposed between the first unbendable portion 241 and the third unbendable portion 243 of the flexible display 240. For example, the first bendable portion 244 of the flexible display 240 may be disposed on the first hinge structure 250 connecting the first housing part 210 and the second housing part 220. The second bendable portion 245 of the flexible display 240 may be disposed between the second unbendable portion 242 and the third unbendable portion 243 of the flexible display 240. For example, the second bendable portion 245 of the flexible display 240 may be disposed on the second hinge structure 260 connecting the second housing part 220 and the third housing part 230.

The first hinge structure 250 and the second hinge structure 260 may face substantially the same direction as the first unbendable portion 241 of the flexible display 240, the second unbendable portion 242 of the flexible display 240, and the third unbendable portion 243 of the flexible display 240. In the first state 200a, the first bendable portion 244 and the second bendable portion 245 may be disposed in substantially the same horizontal plane as the first unbendable portion 241, the second unbendable portion 242, and the third unbendable portion 243.

The first hinge structure 250 and the second hinge structure 260 may provide a second state 200b of the electronic device 200. In the second state 200b, the first unbendable portion 241 of the flexible display 240 may face the second unbendable portion 242 of the flexible display 240, and the third unbendable portion 243 of the flexible display 240 may face the same direction as the second unbendable portion 242 of the flexible display 240. For example, the second unbendable portion 242 and the third unbendable portion 243 may be disposed in substantially the same horizontal plane.

In the second state 200b, as the first bendable portion 244 of the flexible display 240 is bent by the first hinge structure 250, the first bendable portion 244 of the flexible display 240 may be folded, so that the first unbendable portion 241 of the flexible display 240 and the second unbendable portion 242 of the flexible display 240 face different directions.

In the second state 200b, as the second bendable portion 245 of the flexible display 240 is maintained in the unfolded state by the second hinge structure 260, the second bendable portion 245 of the flexible display 240 may be unfolded so that the second unbendable portion 242 of the flexible display 240 and the third unbendable portion 243 of the flexible display 240 face the same direction.

The first hinge structure 250 and the second hinge structure 260 may provide a third state 200c of the electronic device 200. In the third state 200c, the second unbendable portion 242 of the flexible display 240 may face the first unbendable portion 241 of the flexible display 240, and the third unbendable portion 243 of the flexible display 240 may face the rear surface of the first housing part 210.

In the third state 200c, as the first bendable portion 244 of the flexible display 240 is bent by the first hinge structure 250, the first bendable portion 244 of the flexible display 240 may be folded so that the first unbendable portion 241 of the flexible display 240 and the second unbendable portion 242 of the flexible display 240 face different directions.

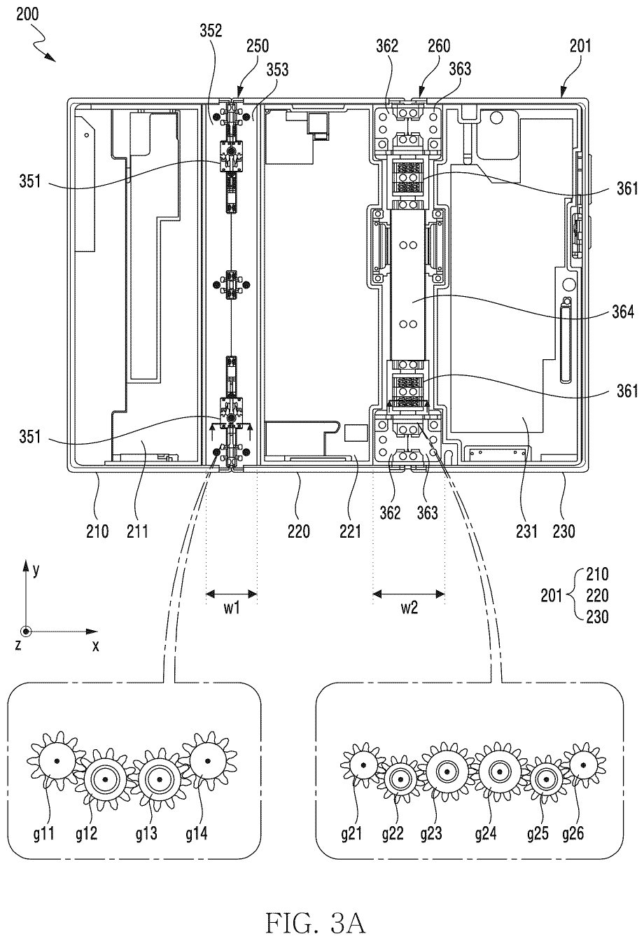

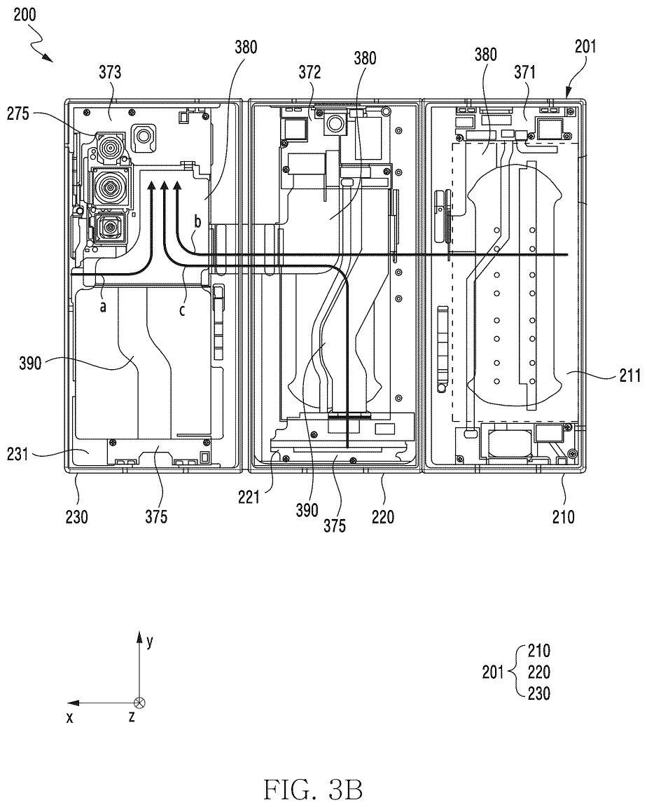

In the third state 200c, the second bendable portion 245 of the flexible display 240 is bent by the second hinge structure 260, the second bendable portion 245 of the flexible display 240 may be folded so that the second unbendable portion 242 of the flexible display 240 and the third unbendable portion 243 of the flexible display 240 face different directions. The second bendable portion 245 may further include a first deformation portion 245a, a second deformation portion 245b, and a planar portion 245c. The first deformation portion 245a may be disposed between the planar portion 245c and the second unbendable portion 242, and the second deformation portion 245b may be disposed between the planar portion 245c and the third unbendable portion 243. The planar portion 245c may be disposed between the first deformation portion 245a and the second deformation portion 245b. The planar portion 245c may be supported by a support plate (e.g., the support plate 364 of FIG. 3A) that is distinct from the hinge plates (e.g., the third hinge plate 362 and the fourth hinge plate 363 of FIG. 3A) of the second hinge structure 260. Regardless of the state of the electronic device 200, the planar portion 245c may maintain a planar surface. The first deformation portion 245a and the second deformation portion 245b may be unfolded in the first state 200a and the second state 200b, and in the third state 200c, the first deformation portion 245a and the second deformation portion 245b may be bent so that the second unbendable portion 242 and the third unbendable portion 243 face different directions. In the third state 200c, the first housing part 210 may be disposed between the second housing part 220 and the third housing part 230. In the third state 200c, the second bendable portion 245 of the flexible display 240 disposed on the second hinge structure 260 may partially face the side surface 210c of the first housing part 210.

A display region of the flexible display 240 may include a first display region 240a, a second display region 240b, and a third display region 240c. The display region indicates a region capable of providing visual information from the flexible display 240. In the first state 200a, the entire display region of the flexible display 240 may be viewed from the front surface of the housing structure 201. For example, in the first state 200a, the first display region 240a, the second display region 240b, and the third display region 240c of the flexible display 240 may be visually exposed. The electronic device 200 may provide, to the user, a large display region including the first display region 240a, the second display region 240b, and the third display region 240c.

In the second state 200b, the display region of the flexible display 240 may be partially visible from the front surface of the third housing part 230. For example, the third display region 240c may be visually exposed, and the first display region 240a and the second display region 240b may not be visually exposed.

In the third state 200c, the display region of the flexible display 240 may not be visible. For example, in the third state 200c, the first display region 240a, the second display region 240b, and the third display region 240c of the flexible display 240 may not be visually exposed.

As a non-limiting example, when the flexible display 240 is used to display a screen in the first state 200a of the electronic device 200, the first display region 240a, the second display region 240b, and the third display region 240c of the flexible display 240 may be activated. As a non-limiting example, in the third state 200c, the first display region 240a, the second display region 240b, and the third display region 240c of the flexible display 240 may be deactivated. As a non-limiting example, in the second state 200b of the electronic device 200, when the flexible display 240 is used to display a screen, the third display region 240c may be activated, and the first display region 240a and the second display region 240b of the flexible display 240 may be deactivated.

As a non-limiting example, when the flexible display 240 is used to display a screen in the first state 200a of the electronic device 200, the first display region 240a, the second display region 240b, and the third display region 240c of the flexible display 240 may display visual information. As a non-limiting example, in the third state 200c, the first display region 240a, the second display region 240b, and the third display region 240c of the flexible display 240 may provide a black image. As a non-limiting example, in the second state 200b of the electronic device 200, when the flexible display 240 is used to display a screen, the third display region 240c may provide visual information, and the first display region 240a and the second display region 240b of the flexible display 240 may provide a black image.

FIG. 3A is a plan view of an electronic device from which a flexible display is removed according to an embodiment of the disclosure. FIG. 3B is a rear view of an electronic device from which a rear cover and a display are removed according to an embodiment of the disclosure.

Referring to FIGS. 3A and 3B, the electronic device 200 may include a first hinge structure 250 and a second hinge structure 260. A first width w1 of the first hinge structure 250 may be narrower than a second width w2 of the second hinge structure 260. A difference between the first width w1 of the first hinge structure 250 and the second width w2 of the second hinge structure 260 may be greater than or equal to a thickness of the first housing part 210. For example, the second hinge structure 260 may have the second width w2 wider than the first width w1 so that the first housing part 210 is disposed between the second housing part 220 and the third housing part 230 according to the third state 200c. The first hinge structure 250 may be referred to as a narrow hinge structure in terms of having a narrower width than the second hinge structure 260. The second hinge structure 260 may be referred to as a wide hinge structure in terms of having a wider width than the first hinge structure 250.

The first hinge structure 250 may include a first set of gears 351, a first hinge plate 352, and a second hinge plate 353. The first hinge plate 352 may be coupled to a first support portion 211 of the first housing part 210. The second hinge plate 353 may be coupled to a second support portion 221 of the second housing part 220. Gears g11, g12, g13, and g14 included in the first set of gears 351 may be configured to rotate the first hinge plate 352 and the second hinge plate 353. For example, the gears g11, g12, g13, and g14 included in the first set of gears 351 may rotate the second hinge plate 353 (or the second housing part 220) by linking with a rotation of the first hinge plate 352 (or the first housing part 210). After the first hinge plate 352 (or the first housing part 210) rotates, the gears g11, g12, g13, and g14 included in the first set of gears 351 may rotate in accordance with a rotation of the first hinge plate 352 (or the first housing part 210). The second hinge plate 353 (or the second housing part 220) may rotate by linking with the rotation of the first hinge plate 352 in accordance with the rotation of the gears included in the first set of gears 351. The gears g11, g12, g13, and g14 included in the first set of gears 351 may include a first gear g11, a second gear g12, a third gear g13, and a fourth gear g14. The first gear g11 may be disposed adjacent to the first hinge plate 352, and the fourth gear g14 may be disposed adjacent to the second hinge plate 353. The second gear g12 and the third gear g13 may be disposed between the first gear g11 and the fourth gear g14. The first gear g11, the second gear g12, the third gear g13, and the fourth gear g14 may be sequentially engaged. According to a rotation of the first gear g11 in a first rotation direction (e.g., clockwise), the second gear g12 engaged with the first gear g11 may be rotated in a second rotation direction (e.g., counterclockwise) opposite to the first rotation direction. According to the rotation of the second gear g12 in the second rotation direction, the third gear g13 engaged with the second gear g12 may be rotated in the first rotation direction. The fourth gear g14 may be rotated in the second rotation direction according to the rotation of the third gear g13 in the first rotation direction. As the first gear g11 and the fourth gear g14 rotate in different directions, the first housing part 210 connected to the first hinge plate 352 and the second housing part 220 connected to the second hinge plate 353 may be folded or unfolded.

The second hinge structure 260 may include a second set of gears 361, a third hinge plate 362, a fourth hinge plate 363, and a support plate 364. The third hinge plate 362 may be coupled to the second support portion 221 of the second housing part 220. The fourth hinge plate 363 may be coupled to a third support portion 231 of the third housing part 230. Gears g21, g22, g23, g24, g25, and g26 included in the second set of gears 361 may be configured to rotate the third hinge plate 362 and the fourth hinge plate 363. For example, the gears g21, g22, g23, g24, g25, and g26 included in the second set of gears 361 may rotate the fourth hinge plate 363 (or the third housing part 230) by linking with a rotation of the third hinge plate 362 (or the second housing part 220). After the third hinge plate 362 (or the second housing part 220) is rotated, the gears g21, g22, g23, g24, g25, and g26 included in the second set of gears 361 may rotate according to the rotation of the third hinge plate 362 (or the second housing part 220). The fourth hinge plate 363 (or the third housing part 230) may be rotated by linking with the rotation of the third hinge plate 362 according to the rotation of the gears g21, g22, g23, g24, g25, and g26 included in the second set of gears 361.

The gears g21, g22, g23, g24, g25, and g26 included in the second set of gears 361 may include a first gear g21, a second gear g22, a third gear g23, a fourth gear g24, a fifth gear g25, and a sixth gear g26. The first gear g21 may be disposed adjacent to the third hinge plate 362, and the sixth gear g26 may be disposed adjacent to the fourth hinge plate 363. The second gear g22, the third gear g23, the fourth gear g24, and the fifth gear g25 may be disposed between the first gear g21 and the sixth gear g26. The first gear g21, the second gear g22, the third gear g23, the fourth gear g24, the fifth gear g25, and the sixth gear g26 may be sequentially engaged. According to a rotation of a first rotation direction (e.g., clockwise) of the first gear g21, the second gear g22 engaged with the first gear g21 may be rotated in a second rotation direction (e.g., counterclockwise) opposite to the first rotation direction. According to the rotation of the second gear g22 in the second rotation direction, the third gear g23 engaged with the second gear g22 may be rotated in the first rotation direction. According to the rotation of the third gear g23 in the first rotation direction, the fourth gear g24 may be rotated in the second rotation direction. According to the rotation of the fourth gear g24 in the second rotation direction, the fifth gear g25 engaged with the fourth gear g24 may be rotated in the first rotation direction. According to the rotation of the fifth gear g25 in the first rotation direction, the sixth gear g26 engaged with the fifth gear g25 may be rotated in the second rotation direction. As the first gear g21 and the sixth gear g26 rotate in different directions, the second housing part 220 connected to the third hinge plate 362 and the third housing part 230 connected to the fourth hinge plate 363 may be folded or unfolded.

The first hinge structure 250 and the second hinge structure 260 may further include a spiral structure. The spiral structure may include a helical spiral groove formed in each hinge plate or a rotation member connected to the hinge plate and a moving member sliding along the spiral groove. The hinge plates connected to the hinge structure may be configured to rotate at substantially the same angular displacement through the spiral structure.

The electronic device 200 may include a first printed circuit board 371, a second printed circuit board 372, and a third printed circuit board 373.

The first printed circuit board 371 may be disposed on the first support portion 211 of the first housing part 210. Hardware components within the first housing part 210 may be mounted in the first printed circuit board 371. The second printed circuit board 372 may be disposed on the second support portion 221 of the second housing part 220. The third printed circuit board 373 may be disposed in the third support portion 231 of the third housing part 230. Hardware components within the third housing part 230 may be mounted in the third printed circuit board 373.

Hardware components disposed on the first printed circuit board 371 may support or operate independently of hardware components disposed on the second printed circuit board 372 and/or hardware components disposed on the third printed circuit board 373.

The hardware components disposed on the second printed circuit board 372 may support or operate independently of the hardware components disposed on the first printed circuit board 371 or the third printed circuit board 373. The hardware components disposed on the second printed circuit board 372 may include a speaker, a front camera, and/or display driving circuitry.

The hardware components disposed on the third printed circuit board 373 may include at least one processor (e.g., an application processor (AP), a communication processor (CP)) including processing circuitry, memory including one or more storage media, communication circuitry, and a rear camera 275. The rear camera 275 may be exposed through a structure (e.g., opening) of the rear surface of the third housing part 230.

The electronic device 200 may further include a sub-printed circuit board 375, flexible printed circuit boards 380 and 390. The sub-printed circuit board 375 may be disposed on at least a portion of the first housing part 210, the second housing part 220, and the third housing part 230. The flexible printed circuit boards 380 and 390 may include a first flexible printed circuit board 380 and a second flexible printed circuit board 390. The first flexible printed circuit board 380 may electrically connect printed circuit boards disposed on each of the housing parts 210, 220, and 230. The second flexible printed circuit board 390 may connect a printed circuit board within a housing part in which the sub-printed circuit board 375 is disposed and the sub-printed circuit board 375, by the second flexible printed circuit board 390.

Components within the electronic device 200 may be connected to at least one processor within the third printed circuit board 373 through the flexible printed circuit boards 380 and 390. For example, a signal received from an antenna disposed in the third housing part 230 may be transmitted to the third printed circuit board 373 on which at least one processor (e.g., the processor 120) (e.g., AP or CP) is disposed through a signal path (a) provided by the first flexible printed circuit board 380. A driving circuit for the flexible display 240 disposed within the first housing part 210 may be connected to the third printed circuit board 373 on which at least one processor (e.g., AP) is disposed through a signal path (b) provided by the sub-printed circuit board 375 and the first flexible printed circuit board 380. A driving circuit for the display 270 connected to the sub-printed circuit board 375 disposed on the second housing part 220 may be electrically connected to the third printed circuit board 373 on which at least one processor (e.g., AP) is disposed through a signal path (c) provided by the sub-printed circuit board 375 and the first flexible printed circuit board 380 and the second flexible printed circuit board 390.

The electronic device 200 may further include batteries (e.g., the battery 189). Each of the batteries may be attached to support portions 211, 221, and 231 included in the housing parts 210, 220, and 230. The support portions 211, 221, and 231 may support rechargeable batteries.

The arrangement of hardware components is exemplary, unlike the above description, the rear camera 275 and the second printed circuit board 372 may be disposed in the third housing part 230, and the third printed circuit board 373 may be disposed in the second housing part 220.

It is illustrated that the first housing part 210 and the third housing part 230 rotate in opposite directions with respect to the second housing part 220, but are not limited thereto. For example, while changing from the first state 200a to the third state 200c, the first housing part 210 may rotate counterclockwise with respect to the second housing part 220, and the third housing part 230 may rotate counterclockwise with respect to the second housing part 220. As the first housing part 210 and the third housing part 230 rotate in the same direction, a portion of the display region of the flexible display 240 within the second state may be visually exposed.

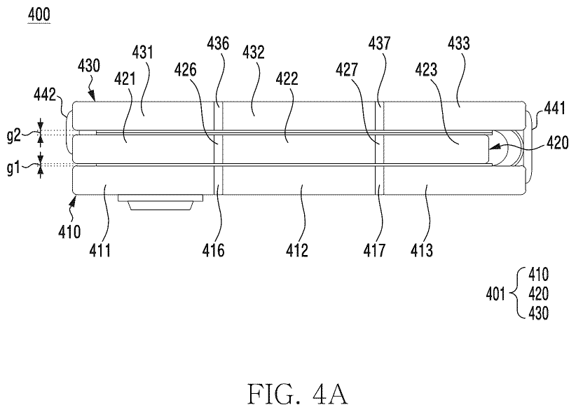

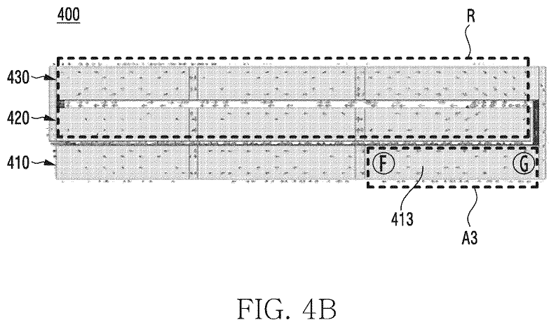

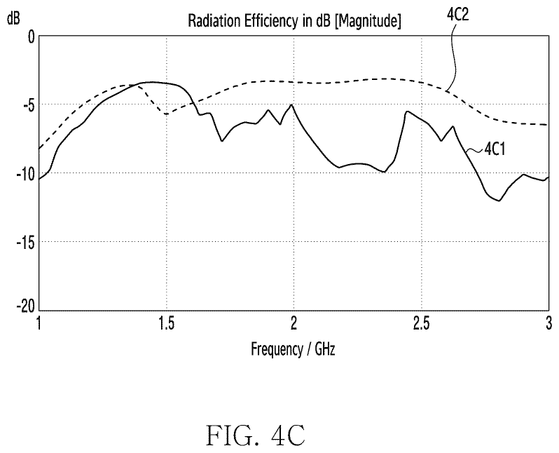

FIG. 4A indicates an electronic device in a multi-folded state according to an embodiment of the disclosure. FIG. 4B indicates a current flow of an electronic device in a multi-folded state when an antenna operates according to an embodiment of the disclosure. FIG. 4C is a graph indicating radiation efficiency of an electronic device in a multi-folded state and an unfolded state according to an embodiment of the disclosure.

Referring to FIG. 4A, according to an embodiment of the disclosure, a multi-foldable electronic device 400 (hereinafter referred to as an electronic device 400) (e.g., the electronic device 200) may include a foldable housing 401.

The foldable housing 401 may include a plurality of housing parts. Each of the plurality of housing parts may be rotatably coupled to an adjacent housing part so as to transition between the multi-folded state (e.g., the third state 200c) and the unfolded state (e.g., the first state 200a) of the foldable housing 401.

For example, the foldable housing 401 may include a first housing part 410 (e.g., the third housing part 230), a second housing part 420 (e.g., the first housing part 210), and a third housing part 430 (e.g., the second housing part 220). For example, the first housing part 410 may be rotatably coupled to a first side of the third housing part 430. For example, the second housing part 420 may be rotatably coupled to a second side of the third housing part 430, opposite to the first side. The foldable housing 401 may include a first hinge structure 441 (e.g., the second hinge structure 260) rotatably connecting the first housing part 410 and the third housing part 430, and a second hinge structure 442 (e.g., the first hinge structure 250) rotatably connecting the second housing part 420 and the third housing part 430.

As illustrated in FIG. 4A, in the multi-folded state of the electronic device 400, the second housing part 420 may be positioned on the first housing part 410, and the third housing part 430 may be positioned on the second housing part 420. Although not illustrated, in the unfolded state (e.g., the first state 200a) of the electronic device 400, the first housing part 410, the second housing part 420, and the third housing part 430 may be positioned on substantially the same plane.

In an embodiment of the disclosure, the first housing part 410 may include a plurality of conductive portions forming at least a portion of a lateral surface of the first housing part 410 and one or more non-conductive portions interposed between the plurality of conductive portions. For example, the first housing part 410 may include a first conductive portion 411, a second conductive portion 412, a third conductive portion 413, a first non-conductive portion 416, and a second non-conductive portion 417.

The second conductive portion 412 may be disposed between the first conductive portion 411 and the third conductive portion 413. The second conductive portion 412 may be spaced apart from the first conductive portion 411, and the first non-conductive portion 416 may be disposed between the first conductive portion 411 and the second conductive portion 412. For example, the first non-conductive portion 416 may extend from a first end of the first conductive portion 411 to a first end of the second conductive portion 412. The third conductive portion 413 may be spaced apart from the second conductive portion 412, and the second non-conductive portion 417 may be disposed between the second conductive portion 412 and the third conductive portion 413. For example, the second non-conductive portion 417 may extend from a second end of the second conductive portion 412 to a first end of the third conductive portion 413. The first conductive portion 411, the first non-conductive portion 416, the second conductive portion 412, the second non-conductive portion 417, and the third conductive portion 413 may form a portion of the lateral surface of the first housing part 410, for example without limitation, an upper lateral surface or a lower lateral surface of the first housing part 410.

In an embodiment of the disclosure, the second housing part 420 may include a plurality of conductive portions forming at least a portion of a lateral surface of the second housing part 420 and one or more non-conductive portions interposed between the plurality of conductive portions. For example, the second housing part 420 may include a first conductive portion 421, a second conductive portion 422, a third conductive portion 423, a first non-conductive portion 426, and a second non-conductive portion 427.

The second conductive portion 422 may be disposed between the first conductive portion 421 and the third conductive portion 423. The second conductive portion 422 may be spaced apart from the first conductive portion 421, and the first non-conductive portion 426 may be disposed between the first conductive portion 421 and the second conductive portion 422. For example, the first non-conductive portion 426 may extend from a first end of the first conductive portion 421 to a first end of the second conductive portion 422. The third conductive portion 423 may be spaced apart from the second conductive portion 422, and the second non-conductive portion 427 may be disposed between the second conductive portion 422 and the third conductive portion 423. For example, the second non-conductive portion 427 may extend from a second end of the second conductive portion 422 to a first end of the third conductive portion 423. The first conductive portion 421, the first non-conductive portion 426, the second conductive portion 422, the second non-conductive portion 427, and the third conductive portion 423 may form a portion of the lateral surface of the second housing part 420, for example without limitation, an upper lateral surface or a lower lateral surface of the second housing part 420.

In an embodiment of the disclosure, the third housing part 430 may include a plurality of conductive portions forming at least a portion of a lateral surface of the third housing part 430 and one or more non-conductive portions interposed between the plurality of conductive portions. For example, the third housing part 430 may include a first conductive portion 431, a second conductive portion 432, a third conductive portion 433, a first non-conductive portion 436, and a second non-conductive portion 437.

The second conductive portion 432 may be disposed between the first conductive portion 431 and the third conductive portion 433. The second conductive portion 432 may be spaced apart from the first conductive portion 431, and the first non-conductive portion 436 may be disposed between the first conductive portion 431 and the second conductive portion 432. For example, the first non-conductive portion 436 may extend from a first end of the first conductive portion 431 to a first end of the second conductive portion 432. The third conductive portion 433 may be spaced apart from the second conductive portion 432, and the second non-conductive portion 437 may be disposed between the second conductive portion 432 and the third conductive portion 433. For example, the second non-conductive portion 437 may extend from a second end of the second conductive portion 432 to a first end of the third conductive portion 433. The first conductive portion 431, the first non-conductive portion 436, the second conductive portion 432, the second non-conductive portion 437, and the third conductive portion 433 may form a portion of the lateral surface of the third housing part 430, for example without limitation, an upper lateral surface or a lower lateral surface of the third housing part 430.

In the multi-folded state of the electronic device 400, the first conductive portion 411 of the first housing part 410 may at least partially face the first conductive portion 421 of the second housing part 420. In the multi-folded state of the electronic device 400, the second conductive portion 412 of the first housing part 410 may at least partially face the second conductive portion 422 of the second housing part 420. In the multi-folded state of the electronic device 400, the third conductive portion 413 of the first housing part 410 may at least partially face the third conductive portion 423 of the second housing part 420.

In the multi-folded state of the electronic device 400, the first conductive portion 431 of the third housing part 430 may at least partially face the first conductive portion 421 of the second housing part 420. In the multi-folded state of the electronic device 400, the second conductive portion 432 of the third housing part 430 may at least partially face the second conductive portion 422 of the second housing part 420. In the multi-folded state of the electronic device 400, the third conductive portion 433 of the third housing part 430 may at least partially face the third conductive portion 423 of the second housing part 420.

In the multi-folded state of the electronic device 400, a first gap g1 between the first housing part 410 and the second housing part 420 may be, for example without limitation, approximately 0.3 mm or less. In the multi-folded state of the electronic device 400, a second gap g2 between the second housing part 420 and the third housing part 430 may be, for example without limitation, approximately 0.6 mm or less.

In an embodiment of the disclosure, at least one of the first conductive portion 411, the second conductive portion 412, and the third conductive portion 413 of the first housing part 410 may be used as an antenna radiator of the electronic device 400. For example, wireless communication circuitry (e.g., the wireless communication module 192) of the electronic device 400 may transmit and/or receive a radio frequency (RF) signal through the at least one of the first conductive portion 411, the second conductive portion 412, and the third conductive portion 413 of the first housing part 410.

In an embodiment of the disclosure, at least one of the first conductive portion 431, the second conductive portion 432, and the third conductive portion 433 of the third housing part 430 may be used as an antenna radiator of the electronic device 400. For example, the wireless communication circuitry of the electronic device 400 may transmit and/or receive a radio frequency (RF) signal through the at least one of the first conductive portion 431, the second conductive portion 432, and the third conductive portion 433 of the third housing part 430.

When a conductive portion of the first housing part 410 operates as an antenna in the multi-folded state of the electronic device 400, a current flowing through the conductive portion of the first housing part 410 may be induced to a conductive portion of the second housing part 420 adjacent thereto. In addition, when a conductive portion of the third housing part 430 operates as an antenna in the multi-folded state of the electronic device 400, a current flowing through the conductive portion of the third housing part 430 may be induced to the conductive portion of the second housing part 420 adjacent thereto.

For example, referring to FIG. 4B, in the multi-folded state of the electronic device 400, the third conductive portion 413 of the first housing part 410 may operate as an antenna A3 including a feeding point F and a ground point G. In drawings, the feeding point F may be a point where the corresponding antenna (or the corresponding conductive portion) is electrically connected to the wireless communication circuitry, and the ground point G may be a point where the corresponding antenna (or the corresponding conductive portion) is electrically connected to ground of the electronic device 400. However, a position of the feeding point F and the ground point G is not limited by an illustrated example, and the position of the feeding point F and the ground point G may be interchanged or formed at a different position from the illustrated example.

As the third conductive position 413 operates as the antenna A3, as illustrated in a region R, the current flowing through the third conductive position 413 of the first housing part 410 may be induced to conductive positions of the second housing part 420 and the third housing part 430 adjacent to the third conductive position 413. In order to reduce a thickness of the electronic device 400, as the first gap g1 between the first housing part 410 and the second housing part 420 and the second gap g2 between the second housing part 420 and the third housing part 430 decrease, an induced current may increase. A current induced to an adjacent conductive portion may produce a parasitic component and simultaneously reduce efficiency of the antenna. For example, referring to FIG. 4C, radiation efficiency 4C1 of the antenna A3 in the multi-folded state of the electronic device 400 may be lower than radiation efficiency 4C1 of the antenna A3 in the unfolded state of the electronic device 400.

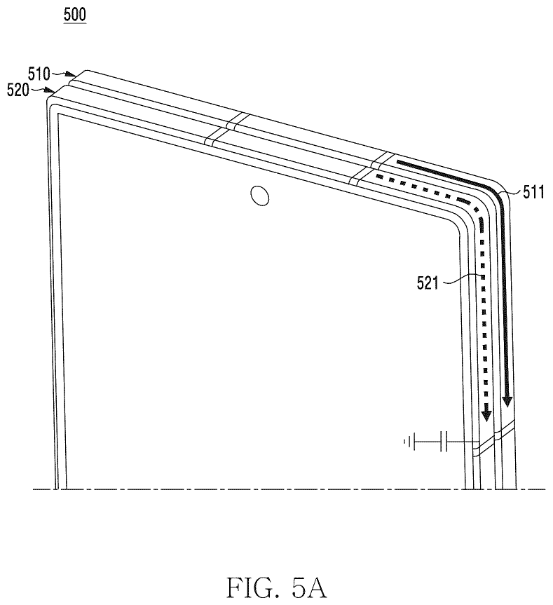

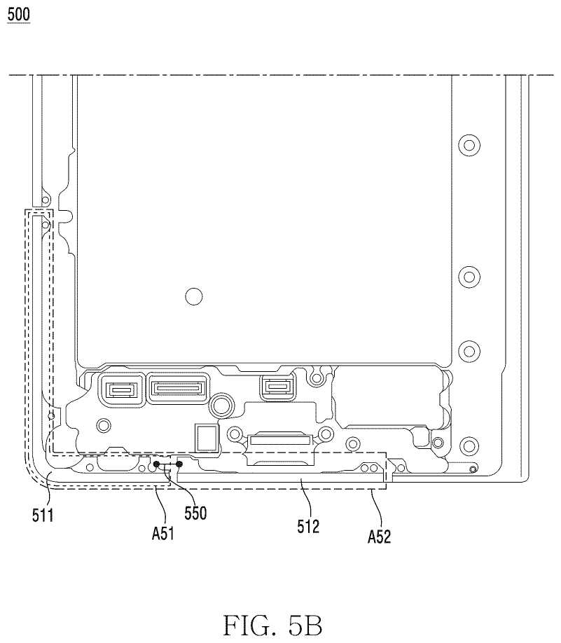

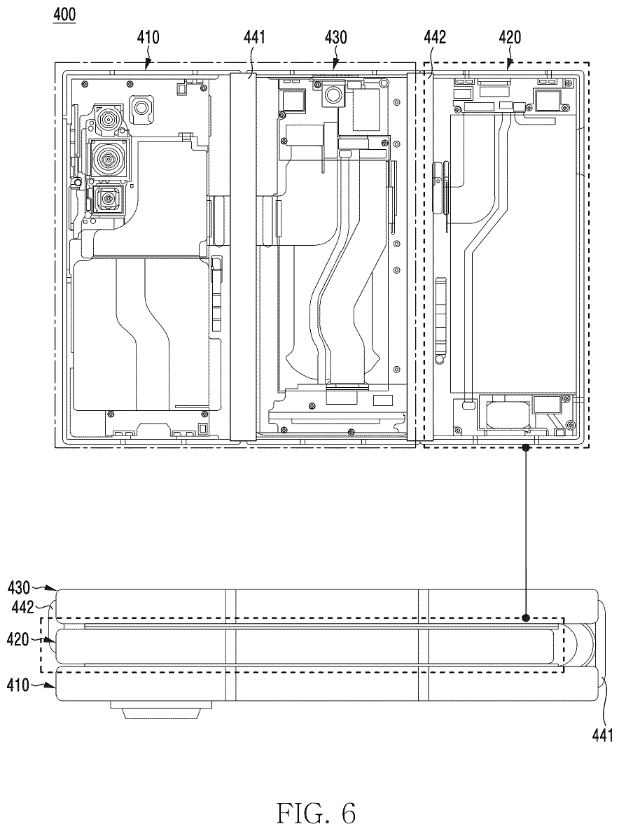

FIGS. 5A and 5B indicates a folded state of an electronic device according to a comparative example according to various embodiments of the disclosure. FIG. 6 is a diagram indicating an electronic device according to an embodiment of the disclosure.

Referring to FIG. 5A, an electronic device 500 according to the comparative example may include a first housing part 510 and a second housing part 520 rotatable with respect to the first housing part 510. In a state in which the electronic device 500 is folded so that the first housing part 510 and the second housing part 520 face each other, a conductive portion 511 of the first housing part 510 may operate as an antenna radiator. When the conductive portion 511 of the first housing part 510 operates as a first antenna radiator, by changing an electrical characteristic of a conductive portion 521 of the second housing part 520 aligned with respect to the conductive portion 511 of the first housing part 510, the conductive portion 521 of the second housing part 520 may be used as a second antenna radiator. Accordingly, performance degradation of an antenna that may occur by a current flowing through the conductive portion 511 of the first housing part 510 being induced to the conductive portion 521 of the second housing part 520 may be prevented or reduced.

Referring to FIG. 5B, the first housing part 510 of the electronic device 500 according to the comparative example may further include another conductive portion 512 spaced apart from the conductive portion 511. In the state in which the electronic device 500 is folded, the conductive portion 511 may operate as an antenna A51. Or, in the state in which the electronic device 500 is folded, the conductive portion 511 and the another conductive portion 512 may be electrically connected through an electrical path 550, and the conductive portion 511 and the another conductive portion 512 may operate together as an antenna A52. However, this method may be effective to increase radiation performance of the antenna in a state in which the electronic device 500 is unfolded, but it may be difficult to address the issue due to an increase in induced current in the state in which the electronic device 500 is folded. In addition, a method of increasing an antenna volume by connecting the conductive portion 511 and the another conductive portion 512 is effective in a low band antenna (e.g., approximately 1 GHz or less), but is not suitable for applying to an antenna in a relatively high frequency band.

Referring to FIG. 6, since a first housing part 410 is connected to a second housing part 420 through a third housing part 430, it may be difficult to use the second housing part 420 facing the first housing part 410 as an antenna radiator in a state in which an electronic device 400 is folded. This may be because a loss is large since a physical distance between the wireless communication circuitry and the second housing part 420 is long, in case that the wireless communication circuitry of the electronic device 400 is disposed in the first housing part 410. Even if the second housing part 420 is used as the antenna, both sides of the second housing part 420 are blocked by a first hinge structure 441 and a second hinge structure 442, and an upper surface and a lower surfaces of the second housing part 420 are blocked by the first housing part 410 and the third housing part 430, so there is a limit to improving the antenna performance of the first housing part 410, using the second housing part 420 as the antenna radiator.

Hereinafter, examples of the electronic device 400 capable of controlling a current induced from the first housing part 410 and the third housing part 430, using the second housing part 420 that is difficult to be used as the antenna radiator are illustrated.

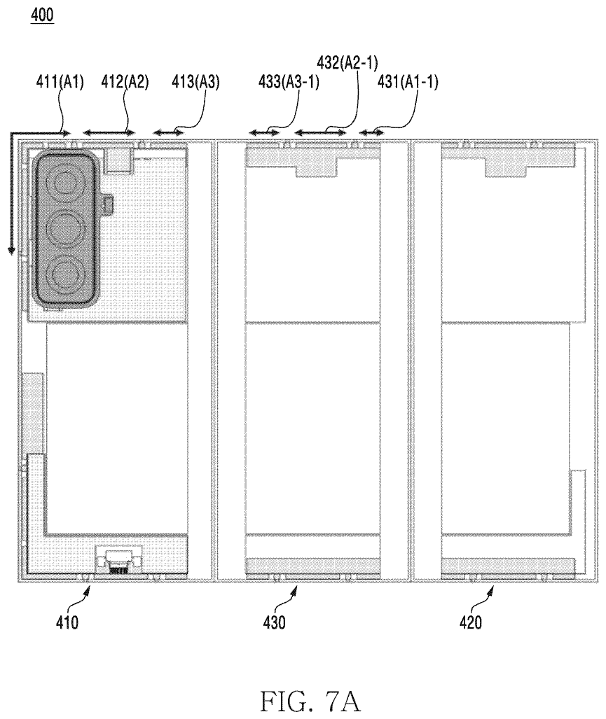

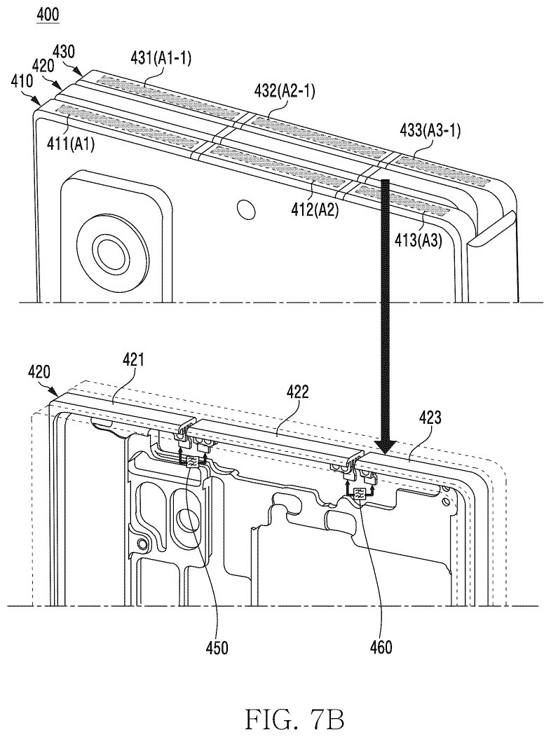

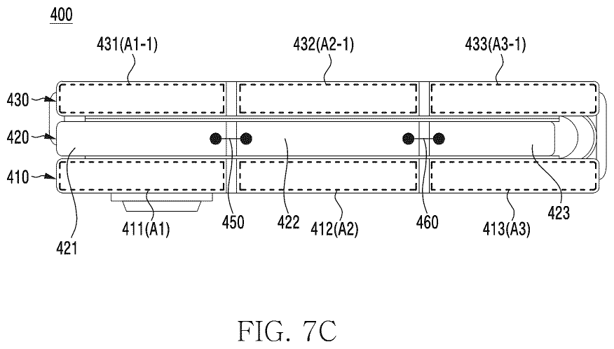

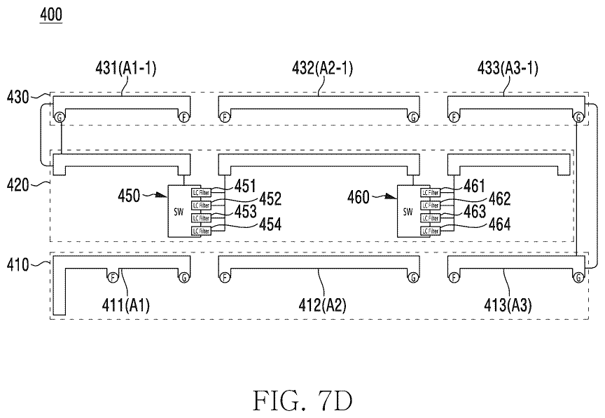

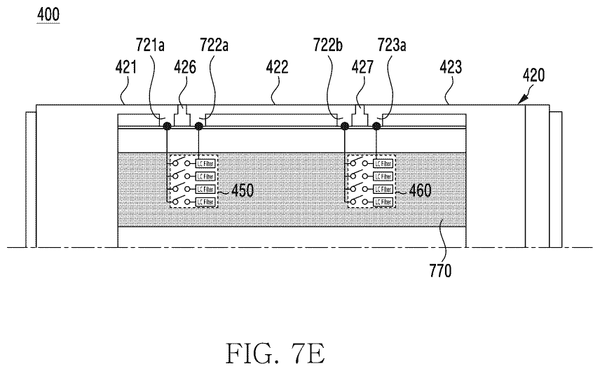

FIG. 7A indicates an electronic device in an unfolded state according to an embodiment of the disclosure. FIG. 7B indicates housing parts of an electronic device in a multi-folded state according to an embodiment of the disclosure. FIGS. 7C and 7D illustrate an electronic device in a multi-folded state according to various embodiments of the disclosure. FIG. 7E indicates a third housing part in which switching circuitry is disposed, according to an embodiment of the disclosure.

Referring to FIGS. 7A, 7B, and 7C, a first conductive portion 411 of a first housing part 410 may operate as a first antenna A1, the second conductive portion 412 of the first housing part 410 may operate as a second antenna A2, and a third conductive portion 413 of the first housing part 410 may operate as a third antenna A3.

A first conductive portion 431 of a third housing part 430 may operate as a fourth antenna A1-1, a second conductive portion 432 of the third housing part 430 may operate as a fifth antenna A2-1, and a third conductive portion 433 of the third housing part 430 may operate as a sixth antenna A3-1. In FIG. 7A, it is illustrated that the antennas A1, A2, and A3 of the electronic device 400 are disposed on an upper end of the first housing part 410, but are not limited thereto. For example, the antennas A1, A2, and A3 of the electronic device 400 may be provided at a lower end of the first housing part 410. For another example, in addition to the antennas A1, A2, and A3 provided at the upper end of the first housing part 410, additional antennas may be provided at the lower end of the first housing part 410.

Referring to FIG. 7A, it is illustrated that the antennas A1-1, A2-1, and A3-1 of the electronic device 400 are disposed on an upper end of the third housing part 430, but are not limited thereto. For example, the antennas A1-1, A2-1, and A3-1 of the electronic device 400 may be provided at a lower end of the third housing part 430. For another example, in addition to the antennas A1-1, A2-1, and A3-1 provided at the upper end of the third housing part 430, more antennas may be provided at the lower end of the third housing part 430.

Referring to FIG. 7B, in the multi-folded state of the electronic device 400, each of the antennas A1, A2, A3, A1-1, A2-1, and A3-1 of the electronic device 400 may operate separately, or may operate simultaneously with at least one of the antennas A1, A2, A3, A1-1, A2-1, and A3-1.

Referring to FIGS. 7B and 7C, according to an embodiment of the disclosure, the electronic device 400 may include first switching circuitry (or circuit) 450 electrically connecting a first conductive portion 421 and a second conductive portion 422 of a second housing part 420 and/or second switching circuitry (or circuit) 460 electrically connecting the second conductive portion 422 and a third conductive portion 423 of the second housing part 420. For example, circuitry, such as the first switching circuitry 450 and the second switching circuitry 460 may be disposed in a printed circuit board (e.g., a printed circuit board 770 of FIG. 7E) in the electronic device 400 and electrically connected to the conductive portions 421, 422, and 423 of the second housing part 420.

In an embodiment of the disclosure, when conductive portions of the first housing part 410 operate as an antenna, the first switching circuitry 450 may be configured to reduce and/or block a current induced to the conductive portions of the second housing part 420 from the conductive portions of the first housing part 410. In addition, when conductive portions of the third housing part 430 operate as an antenna, the first switching circuitry 450 may be configured to reduce and/or block a current induced to the conductive portions of the second housing part 420 from the conductive portions of the third housing part 430. In an embodiment of the disclosure, the first switching circuitry 450 may include one or more filter circuits for reducing and/or blocking the current induced to the conductive portions of the second housing part 420. For example, the one or more filter circuits of the first switching circuitry 450 may include lumped elements. For example, the one or more filter circuits may be a circuit of an outside of the first switching circuitry 450, and in this case, the first switching circuitry 450 may operate by being electrically connected to the one or more filter circuits. For example, the first switching circuitry 450 may include a filter or a lumped element, or may operate by being electrically connected to such circuit or circuit components.

In an embodiment of the disclosure, when the conductive portions of the first housing part 410 operate as an antenna, the second switching circuitry 460 may be configured to reduce and/or block a current induced to the conductive portions of the second housing part 420 from the conductive portions of the first housing part 410. In addition, when conductive portions of the third housing part 430 operate as an antenna, the second switching circuitry 460 may be configured to reduce and/or block a current induced to the conductive portions of the second housing part 420 from the conductive portions of the third housing part 430. In an embodiment of the disclosure, the second switching circuitry 460 may include one or more filter circuits for reducing and/or blocking the current induced to the conductive portions of the second housing part 420. For example, the one or more filter circuits of the second switching circuitry 460 may include lumped elements. For example, the one or more filter circuits may be a circuit of an outside of the second switching circuitry 460, and in this case, the second switching circuitry 460 may operate by being electrically connected to the one or more filter circuits. For example, the second switching circuitry 460 may include a filter or a lumped element, or may operate by being electrically connected to such circuit or circuit components.

For example, referring to FIG. 7D, the first switching circuitry 450 may include at least one of a first circuit 451, a second circuit 452, a third circuit 453, and/or a fourth circuit 454. Each of the first circuit 451, the second circuit 452, the third circuit 453, and the fourth circuit 454 may be referred to as a filter or a filter circuit. For example, the filter or the filter circuit may be included or connected to each of the first circuit 451, the second circuit 452, the third circuit 453, and the fourth circuit 454.

The first switching circuitry 450 may selectively electrically connect the first conductive portion 421 and the second conductive portion 422 of the second housing part 420 through at least one of the first circuit 451, the second circuit 452, the third circuit 453, and/or the fourth circuit 454.

For example, the first switching circuitry 450 may electrically connect the first conductive portion 421 and the second conductive portion 422 of the second housing part 420 through the first circuit 451 while the first conductive portion 411 of the first housing part 410 operates as the first antenna A1. The first circuit 451 of the first switching circuitry 450 may be configured to filter a signal having a frequency corresponding to an operating frequency of the first antenna A1. For example, by filtering the signal corresponding to the operating frequency of the first antenna A1, the first circuit 451 of the first switching circuitry 450 may be configured to reduce and/or block the signal corresponding to the operating frequency of the first antenna A1 from being induced to the conductive portions (e.g., the first conductive portion 421 and/or the second conductive portion 422) of the second housing part 420 from the first conductive portion 411 of the first housing part 410. For example, the first circuit 451 may include one or more lumped elements configured to reduce and/or block the signal corresponding to the operating frequency of the first antenna A1 from being induced to the second housing part 420 from the first housing part 410. For example, the first circuit 451 may include an LC filter (or an LC filter circuit) having the operating frequency of the first antenna A1 and/or a frequency band including the same as a cut-off frequency.

For example, the first switching circuitry 450 may electrically connect the first conductive portion 421 and the second conductive portion 422 of the second housing part 420 through the second circuit 452 while the second conductive portion 412 of the first housing part 410 operates as the second antenna A2. The second circuit 452 of the first switching circuitry 450 may be configured to filter a signal having a frequency corresponding to an operating frequency of the second antenna A2. For example, by filtering the signal corresponding to the operating frequency of the second antenna A2, the second circuit 452 of the first switching circuitry 450 may be configured to reduce and/or block the signal corresponding to the operating frequency of the second antenna A2 from being induced to the conductive portions (e.g., the first conductive portion 421 and/or the second conductive portion 422) of the second housing part 420 from the second conductive portion 412 of the first housing part 410. For example, the second circuit 452 may include one or more lumped elements configured to reduce and/or block the signal corresponding to the operating frequency of the second antenna A2 from being induced to the second housing part 420 from the first housing part 410. For example, the second circuit 452 may include an LC filter (or an LC filter circuit) having the operating frequency of the second antenna A2 and/or a frequency band including the same as a cut-off frequency.

For example, the first switching circuitry 450 may electrically connect the first conductive portion 421 and the second conductive portion 422 of the second housing part 420 through the third circuit 453 while the first conductive portion 431 of the third housing part 430 operates as the fourth antenna A1-1. The third circuit 453 of the first switching circuitry 450 may be configured to filter a signal having a frequency corresponding to an operating frequency of the fourth antenna A1-1. For example, by filtering the signal corresponding to the operating frequency of the fourth antenna A1-1, the third circuit 453 of the first switching circuitry 450 may be configured to reduce and/or block the signal corresponding to the operating frequency of the fourth antenna A1-1 from being induced to the conductive portions (e.g., the first conductive portion 421 and/or the second conductive portion 422) of the second housing part 420 from the first conductive portion 431 of the third housing part 430. For example, the third circuit 453 may include one or more lumped elements configured to reduce and/or block the signal corresponding to the operating frequency of the fourth antenna A1-1 from being induced to the second housing part 420 from the third housing part 430. For example, the third circuit 453 may include an LC filter (or an LC filter circuit) having the operating frequency of the fourth antenna A1-1 and/or a frequency band including the same as a cut-off frequency.

For example, the first switching circuitry 450 may electrically connect the first conductive portion 421 and the second conductive portion 422 of the second housing part 420 through the fourth circuit 454 while the second conductive portion 432 of the third housing part 430 operates as the fifth antenna A2-1. The fourth circuit 454 of the first switching circuitry 450 may be configured to filter a signal having a frequency corresponding to an operating frequency of the fifth antenna A2-1. For example, by filtering the signal corresponding to the operating frequency of the fifth antenna A2-1, the fourth circuit 454 of the first switching circuitry 450 may be configured to reduce and/or block the signal corresponding to the operating frequency of the fifth antenna A2-1 from being induced to the conductive portions (e.g., the first conductive portion 421 and/or the second conductive portion 422) of the second housing part 420 from the second conductive portion 432 of the third housing part 430. For example, the fourth circuit 454 may include one or more lumped elements configured to reduce and/or block the signal corresponding to the operating frequency of the fifth antenna A2-1 from being induced to the second housing part 420 from the third housing part 430. For example, the fourth circuit 454 may include an LC filter (or an LC filter circuit) having the operating frequency of the fifth antenna A2-1 and/or a frequency band including the same as a cut-off frequency.

For example, the second switching circuitry 460 may include at least one of a first circuit 461, a second circuit 462, a third circuit 463, and/or a fourth circuit 464. Each of the first circuit 461, the second circuit 462, the third circuit 463, and the fourth circuit 464 may be referred to as a filter or a filter circuit.

The second switching circuitry 460 may selectively electrically connect the second conductive portion 422 and the third conductive portion 423 of the second housing part 420 through at least one of the first circuit 461, the second circuit 462, the third circuit 463, and/or the fourth circuit 464.

For example, the second switching circuitry 460 may electrically connect the second conductive portion 422 and the third conductive portion 423 of the second housing part 420 through the first circuit 461 while the second conductive portion 412 of the first housing part 410 operates as the second antenna A2. The first circuit 461 of the second switching circuitry 460 may be configured to filter a signal having a frequency corresponding to an operating frequency of the second antenna A2. For example, by filtering the signal corresponding to the operating frequency of the second antenna A2, the first circuit 461 of the second switching circuitry 460 may be configured to reduce and/or block the signal corresponding to the operating frequency of the second antenna A2 from being induced to the conductive portions (e.g., the second conductive portion 422 and/or the third conductive portion 423) of the second housing part 420 from the second conductive portion 412 of the first housing part 410. For example, the first circuit 461 may include one or more lumped elements configured to reduce and/or block the signal corresponding to the operating frequency of the second antenna A2 from being induced to the second housing part 420 from the first housing part 410. For example, the first circuit 461 may include an LC filter (or an LC filter circuit) having the operating frequency of the second antenna A2 and/or a frequency band including the same as a cut-off frequency.

For example, the second switching circuitry 460 may electrically connect the second conductive portion 422 and the third conductive portion 423 of the second housing part 420 through the second circuit 462 while the third conductive portion 413 of the first housing part 410 operates as the third antenna A3. The second circuit 462 of the second switching circuitry 460 may be configured to filter a signal having a frequency corresponding to an operating frequency of the third antenna A3. For example, by filtering the signal corresponding to the operating frequency of the third antenna A3, the second circuit 462 of the second switching circuitry 460 may be configured to reduce and/or block the signal corresponding to the operating frequency of the third antenna A3 from being induced to the conductive portions (e.g., the second conductive portion 422 and/or the third conductive portion 423) of the second housing part 420 from the third conductive portion 413 of the first housing part 410. For example, the second circuit 462 may include one or more lumped elements configured to reduce and/or block the signal corresponding to the operating frequency of the third antenna A3 from being induced to the second housing part 420 from the first housing part 410. For example, the second circuit 462 may include an LC filter (or an LC filter circuit) having the operating frequency of the third antenna A3 and/or a frequency band including the same as a cut-off frequency.

For example, the second switching circuitry 460 may electrically connect the second conductive portion 422 and the third conductive portion 423 of the second housing part 420 through the third circuit 463 while the second conductive portion 432 of the third housing part 430 operates as the fifth antenna A2-1. The third circuit 463 of the second switching circuitry 460 may be configured to filter a signal having a frequency corresponding to an operating frequency of the fifth antenna A2-1. For example, by filtering the signal corresponding to the operating frequency of the fifth antenna A2-1, the third circuit 463 of the second switching circuitry 460 may be configured to reduce and/or block the signal corresponding to the operating frequency of the fifth antenna A2-1 from being induced to the conductive portions (e.g., the second conductive portion 422 and/or the third conductive portion 423) of the second housing part 420 from the second conductive portion 432 of the third housing part 430. For example, the third circuit 463 may include one or more lumped elements configured to reduce and/or block the signal corresponding to the operating frequency of the fifth antenna A2-1 from being induced to the second housing part 420 from the third housing part 430. For example, the third circuit 463 may include an LC filter (or an LC filter circuit) having the operating frequency of the fifth antenna A2-1 and/or a frequency band including the same as a cut-off frequency.

For example, the second switching circuitry 460 may electrically connect the second conductive portion 422 and the third conductive portion 423 of the second housing part 420 through the fourth circuit 464 while the third conductive portion 433 of the third housing part 430 operates as the sixth antenna A3-1. The fourth circuit 464 of the second switching circuitry 460 may be configured to filter a signal having a frequency corresponding to an operating frequency of the sixth antenna A3-1. For example, by filtering the signal corresponding to the operating frequency of the sixth antenna A3-1, the fourth circuit 464 of the second switching circuitry 460 may be configured to reduce and/or block the signal corresponding to the operating frequency of the sixth antenna A3-1 from being induced to the conductive portions (e.g., the second conductive portion 422 and/or the third conductive portion 423) of the second housing part 420 from the third conductive portion 433 of the third housing part 430. For example, the fourth circuit 464 may include one or more lumped elements configured to reduce and/or block the signal corresponding to the operating frequency of the sixth antenna A3-1 from being induced to the second housing part 420 from the third housing part 430. For example, the fourth circuit 464 may include an LC filter (or an LC filter circuit) having the operating frequency of the sixth antenna A3-1 and/or a frequency band including the same as a cut-off frequency.

In an embodiment of the disclosure, the first switching circuitry 450 has been described as including the first filter circuit 451, the second filter circuit 452, the third filter circuit 453, and the fourth filter circuit 454 respectively corresponding to the first conductive portion 411 (or the first antenna A1) of the first housing part 410, the second conductive portion 412 (or the second antenna A2) of the first housing part 410, the first conductive portion 431 (or the fourth antenna A1-1) of the third housing part 430, and the second conductive portion 432 (or the fifth antenna (A2-1) of the third housing part 430, but is not limited thereto. For example, the first antenna A1 using the first conductive portion 411 of the first housing part 410 may be configured to operate in multiple bands. For example, the operating frequency of the first antenna A1 using the first conductive portion 411 of the first housing part 410 may include a first frequency and a second frequency different from the first frequency. In this case, the first filter circuit 451 of the first switching circuitry 450 corresponding to the first conductive portion 411 (or the first antenna A1) may include a filter circuit configured to cut off the first frequency and another filter circuit configured to cut off the second frequency, or may include a filter circuit configured to cut off the first frequency and the second frequency.

For another example, the operating frequency of the first antenna A1 using the first conductive portion 411 of the first housing part 410 may be a third frequency, and the operating frequency of the fourth antenna A1-1 using the first conductive portion 431 of the third housing part 430 may be a fourth frequency substantially the same as the third frequency. In this case, the first filter circuit 451 of the first switching circuitry 450 corresponding to the first conductive portion 411 (or the first antenna A1) of the first housing part 410 and the third filter circuit 453 of the first switching circuitry 450 corresponding to the first conductive portion 431 (or the fourth antenna A1-1) of the third housing part 430 may be integrated into a filter circuit configured to cut off the third frequency and the fourth frequency.

In an embodiment of the disclosure, the second switching circuitry 460 has been described as including the first filter circuit 461, the second filter circuit 462, the third filter circuit 463, and the fourth filter circuit 464 respectively corresponding to the second conductive portion 412 (or the second antenna A2) of the first housing part 410, the third conductive portion 413 (or the third antenna A3) of the first housing part 410, the second conductive portion 432 (or the fifth antenna A2-1) of the third housing part 430, and the third conductive portion 433 (or the sixth antenna A3-1) of the third housing part 430, but is not limited thereto. For example, the second antenna A2 using the second conductive portion 412 of the first housing part 410 may be configured to operate in multiple bands. For example, the operating frequency of the second antenna A2 using the second conductive portion 412 of the first housing part 410 may include a fifth frequency and a sixth frequency different from the fifth frequency. In this case, the first filter circuit 461 of the second switching circuitry 460 corresponding to the second conductive portion 412 (or the second antenna A2) may include a filter circuit configured to cut off the fifth frequency and another filter circuit configured to cut off the sixth frequency, or may include a filter circuit configured to cut off the fifth frequency and the sixth frequency.

For another example, the operating frequency of the second antenna A2 using the second conductive portion 412 of the first housing part 410 may be a seventh frequency, and the operating frequency of the fifth antenna A2-1 using the second conductive portion 432 of the third housing part 430 may be an eighth frequency substantially the same as the seventh frequency. In this case, the first filter circuit 461 of the second switching circuitry 460 corresponding to the second conductive portion 412 (or the second antenna A2) of the first housing part 410 and the third filter circuit 463 of the second switching circuitry 460 corresponding to the second conductive portion 432 (or the fifth antenna A2-1) of the third housing part 430 may be integrated into a filter circuit configured to cut off the seventh frequency and the eighth frequency.

Referring to FIG. 7E, according to an embodiment of the disclosure, the electronic device 400 may include a printed circuit board 770 disposed in the second housing part 420. For example, the first switching circuitry 450 and the second switching circuitry 460 may be disposed on the printed circuit board 770.

In an embodiment of the disclosure, the first conductive portion 421 of the second housing part 420 may include a portion 721a protruding to an inside of the second housing part 420 (or protruding toward the printed circuit board 770).

In an embodiment of the disclosure, the second conductive portion 422 of the second housing part 420 may include a first portion 722a protruding to an inside of the second housing part 420 (or protruding toward the printed circuit board 770) and a second portion 722b protruding to the inside of the second housing part 420 (or protruding toward the printed circuit board 770).

In an embodiment of the disclosure, the third conductive portion 423 of the second housing part 420 may include a portion 723a protruding to an inside of the second housing part 420 (or protruding toward the printed circuit board 770).

In an embodiment of the disclosure, the first switching circuitry 450 may be electrically connected to the portion 721a of the first conductive portion 421 and the first portion 722a of the second conductive portion 422.

In an embodiment of the disclosure, the second switching circuitry 460 may be electrically connected to the second portion 722b of the second conductive portion 422 and the portion 723a of the third conductive portion 423.

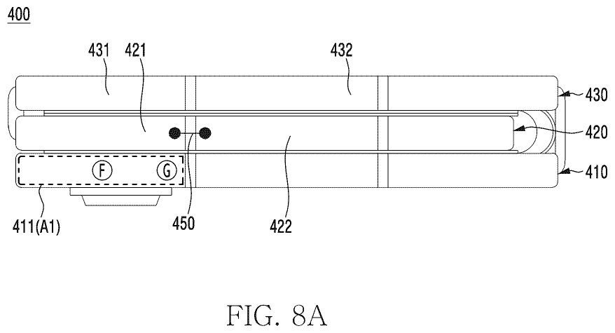

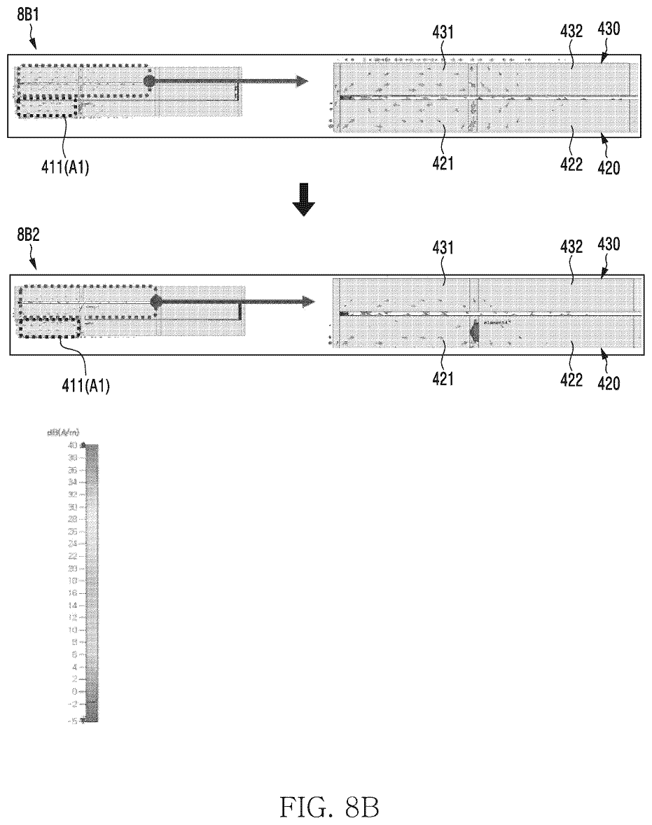

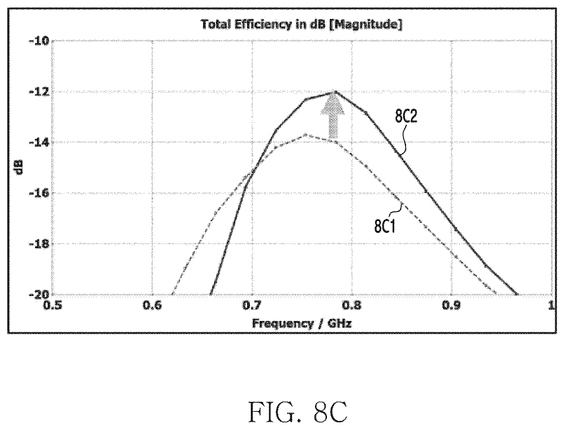

FIG. 8A indicates an electronic device in a multi-folded state according to an embodiment of the disclosure. FIG. 8B indicates a current flow of an electronic device according to a comparative example and a current flow of an electronic device according to an embodiment when a first antenna operates according to an embodiment of the disclosure. FIG. 8C indicates radiation efficiency of a first antenna of an electronic device according to a comparative example and radiation efficiency of a first antenna of an electronic device according to a comparative example according to an embodiment of the disclosure.

A block 8B1 of FIG. 8B indicates a current flow of the electronic device according to a comparative example not including first switching circuitry 450 when a first antenna A1 operates, and a block 8B2 of FIG. 8B indicates a current flow of an electronic device 400 according to an embodiment including the first switching circuitry 450 when the first antenna A1 operates.

A graph 8C1 of FIG. 8C indicates total radiation efficiency of the first antenna A1 of the electronic device according to the comparative example not including the first switching circuitry 450, and a graph 8C2 of FIG. 8C indicates total radiation efficiency of the first antenna A1 of the electronic device 400 according to an embodiment including the first switching circuitry 450.

Referring to FIG. 8A, in the multi-folded state of the electronic device 400, a first conductive portion 411 of a first housing part 410 may operate as the first antenna A1. When the first antenna A1 operates in the multi-folded state of the electronic device 400, the first switching circuitry 450 may reduce and/or block a current from being induced to conductive portions (e.g., a first conductive portion 421 and/or a second conductive portion 422) of a second housing part 420 from the first conductive portion 411 of the first housing part 410. For example, the first antenna A1 may operate in a specific frequency band (e.g., a specific band in a low band) of approximately 1 GHz or less. For example, when the first antenna A1 operates, the first switching circuitry 450 may electrically connect the first conductive portion 421 and the second conductive portion 422 of the second housing part 420 through a filter circuit (e.g., a band stop filter (e.g., the first filter circuit 451)) having a cut-off frequency of approximately 1 GHz.

Accordingly, the current flowing through the housing part operating as the antenna may be reduced and/or prevented from being induced to a neighboring housing part. For example, when the first antenna A1 operates, as illustrated in FIG. 8B, a current (the block 8B2) induced to the first conductive portion 421 and the second conductive portion 422 of the second housing part 420 from the first conductive portion 411 of the electronic device 400 according to an embodiment including the first switching circuitry 450 may be reduced than a current (the block 8B1) induced to the first conductive portion 421 and the second conductive portion 422 of the second housing part 420 from the first conductive portion 411 of the electronic device according to the comparative example not including the first switching circuitry 450.

Accordingly, performance of the first antenna A1 may be improved. For example, as illustrated in FIG. 8C, the total radiation efficiency (the graph 8C2) of the first antenna A1 of the electronic device 400 according to an embodiment including the first switching circuitry 450 may be improved (e.g., in a low band of approximately 1 GHz or less) than the total radiation efficiency (the graph 8C1) of the first antenna A1 of the electronic device according to the comparative example not including the first switching circuitry 450.

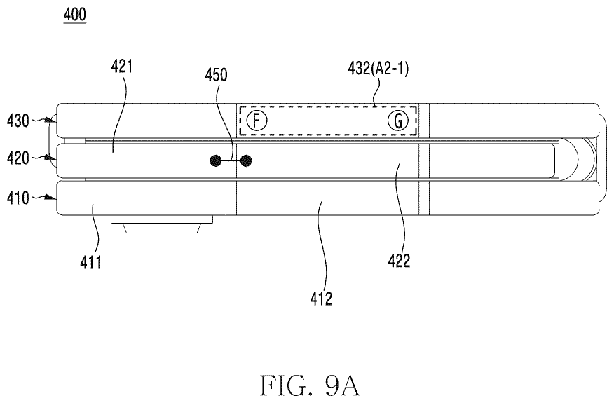

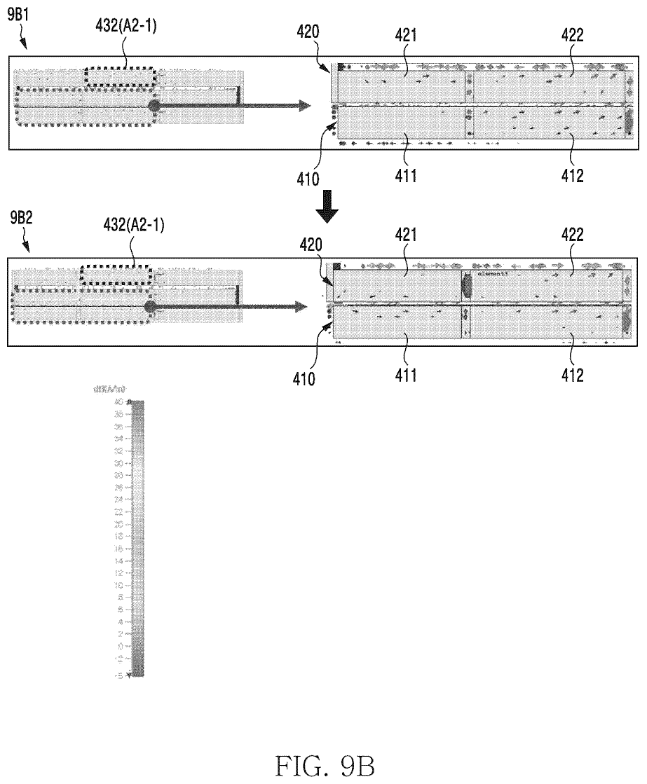

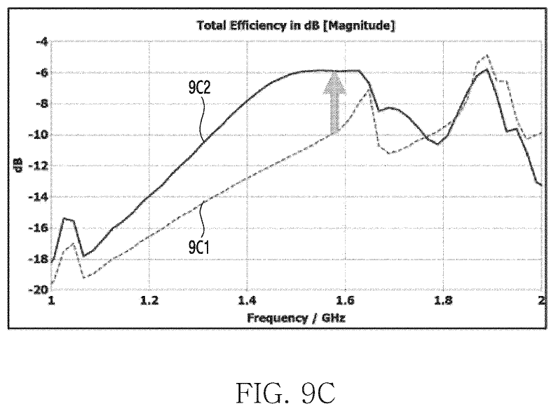

FIG. 9A indicates an electronic device in a multi-folded state according to an embodiment of the disclosure. FIG. 9B indicates a current flow of an electronic device according to a comparative example and a current flow of an electronic device according to an embodiment when a fifth antenna operates according to an embodiment of the disclosure. FIG. 9C indicates radiation efficiency of a fifth antenna of an electronic device according to a comparative example and radiation efficiency of a fifth antenna of an electronic device according to a comparative example according to an embodiment of the disclosure.

A block 9B1 of FIG. 9B indicates a current flow of the electronic device according to a comparative example not including first switching circuitry 450 when a fifth antenna A2-1 operates, and the block 9B2 of FIG. 9B indicates a current flow of an electronic device 400 according to an embodiment including the first switching circuitry 450 when the fifth antenna A2-1 operates.

A graph 9C1 of FIG. 9C indicates total radiation efficiency of the fifth antenna A2-1 of the electronic device according to the comparative example not including the first switching circuitry 450, and a graph 9C2 of FIG. 9C indicates total radiation efficiency of the fifth antenna A2-1 of the electronic device 400 according to an embodiment including the first switching circuitry 450.

Referring to FIG. 9A, in the multi-folded state of the electronic device 400, a second conductive portion 432 of a third housing part 430 may operate as the fifth antenna A2-1. When the fifth antenna A2-1 operates in the multi-folded state of the electronic device 400, the first switching circuitry 450 may reduce and/or block a current from being induced to conductive portions (e.g., a first conductive portion 421 and/or a second conductive portion 422) of a second housing part 420 from the second conductive portion 432 of the third housing part 430. For example, the fifth antenna A2-1 may operate in a specific frequency band (e.g., a GPS L1 band of 1575.42 MHz) of approximately 1.5 GHz or less. For example, the first switching circuitry 450 may electrically connect the first conductive portion 421 and the second conductive portion 422 of the second housing part 420 through a filter circuit (e.g., a high pass filter) (e.g., the fourth filter circuit 454) configured to cut off the frequency band of approximately 1.5 GHz or less when the fifth antenna A2-1 operates.

Accordingly, the current flowing through the housing part operating as the antenna may be reduced and/or prevented from being induced to a neighboring housing part. For example, when the fifth antenna A2-1 operates, as illustrated in FIG. 9B, a current (the block 9B2) induced to the first conductive portion 421 and the second conductive portion 422 of the second housing part 420 from the second conductive portion 432 of the third housing part 430 of the electronic device 400 according to an embodiment including the first switching circuitry 450 may be reduced than a current (the block 9B1) induced to the first conductive portion 421 and the second conductive portion 422 of the second housing part 420 from the second conductive portion 432 of the third housing part 430 of the electronic device according to the comparative example not including the first switching circuitry 450.

Accordingly, performance of the fifth antenna A2-1 may be improved. For example, as illustrated in FIG. 9C, the total radiation efficiency (the graph 9C2) of the fifth antenna A2-1 of the electronic device 400 according to an embodiment including the first switching circuitry 450 may be improved (e.g., in a GPS L1 band of 1575.42 MHz) than the total radiation efficiency (the graph 9C1) of the fifth antenna A2-1 of the electronic device according to the comparative example not including the first switching circuitry 450.

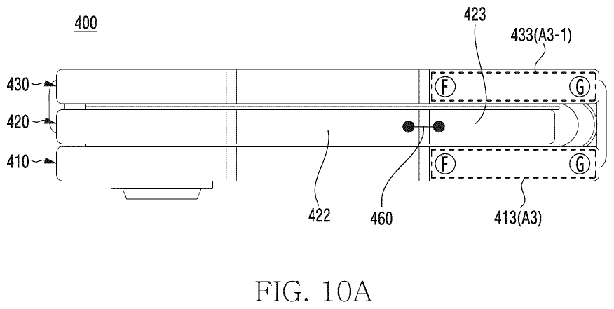

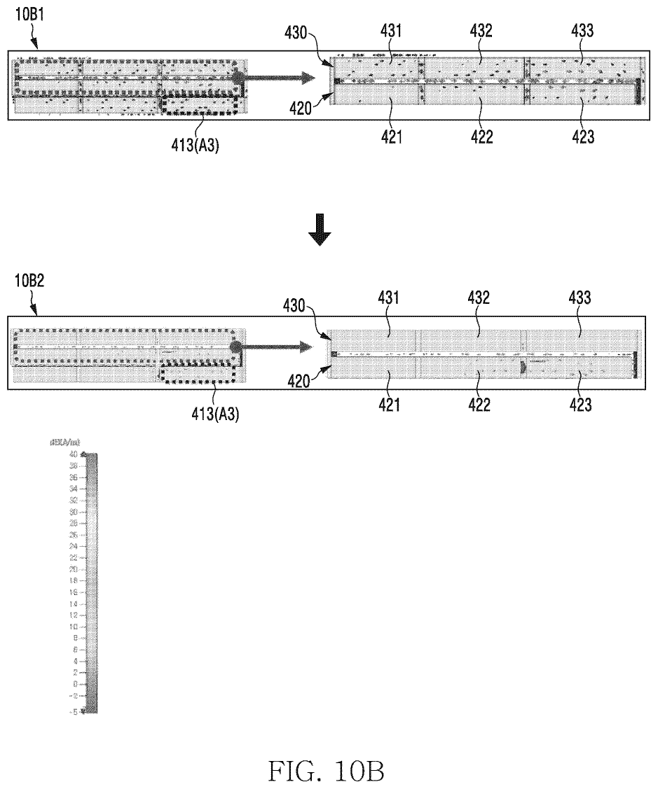

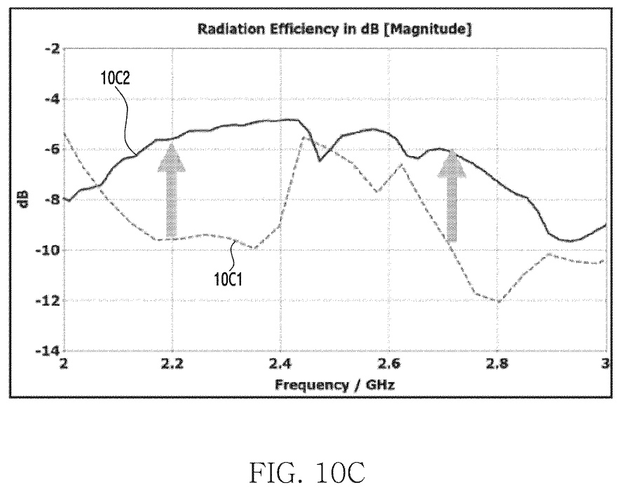

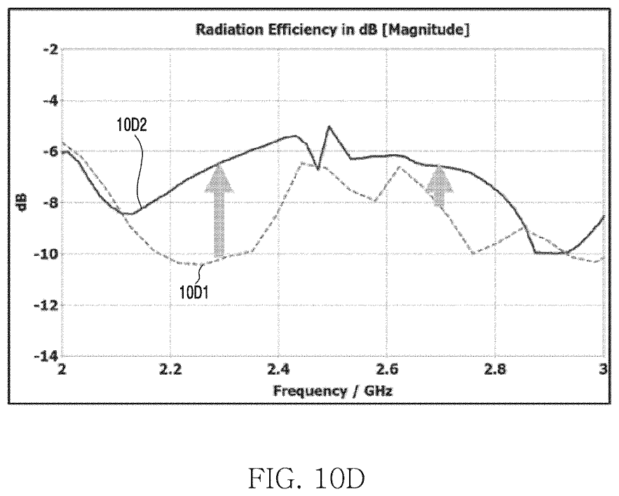

FIG. 10A indicates an electronic device in a multi-folded state according to an embodiment of the disclosure. FIG. 10B indicates a current flow of an electronic device according to a comparative example and a current flow of an electronic device according to an embodiment when a third antenna operates according to an embodiment of the disclosure. FIG. 10C indicates radiation efficiency of a third antenna of an electronic device according to a comparative example and radiation efficiency of a third antenna of an electronic device according to a comparative example according to an embodiment of the disclosure. FIG. 10D indicates radiation efficiency of a sixth antenna of an electronic device according to a comparative example and radiation efficiency of a sixth antenna of an electronic device according to a comparative example according to an embodiment of the disclosure.

A block 10B1 of FIG. 10B indicates a current flow of the electronic device according to the comparative example not including second switching circuitry 460 when a third antenna A3 operates, and a block 10B2 of FIG. 10B indicates a current flow of an electronic device 400 according to an embodiment including the second switching circuitry 460 when the third antenna A3 operates.

A graph 10C1 of FIG. 10C indicates total radiation efficiency of the third antenna A3 of the electronic device according to the comparative example not including the second switching circuitry 460, and a graph 10C2 of FIG. 10C indicates total radiation efficiency of the third antenna A3 of the electronic device 400 according to an embodiment including the second switching circuitry 460.

A graph 10D1 of FIG. 10D indicates total radiation efficiency of a sixth antenna A3-1 of the electronic device according to the comparative example not including the second switching circuitry 460, and a graph 10D2 of FIG. 10D indicates total radiation efficiency of the sixth antenna A3-1 of the electronic device 400 according to an embodiment including the second switching circuitry 460.

Referring to FIG. 10A, in a multi-folded state of the electronic device 400, a third conductive portion 413 of a first housing part 410 may operate as the third antenna A3. In addition, in the multi-folded state of the electronic device 400, a third conductive portion 433 of a third housing part 430 may operate as the sixth antenna A3-1. When the third antenna A3 operates in the multi-folded state of the electronic device 400, the second switching circuitry 460 may reduce and/or block a current from being induced to conductive portions (e.g., a second conductive portion 422 and/or a third conductive portion 423) of a second housing portion 420 from the third conductive portion 413 of the first housing part 410. In addition, when the sixth antenna A3-1 operates in the multi-folded state of the electronic device 400, the second switching circuitry 460 may reduce and/or block the current from being induced to the conductive portions (e.g., the second conductive portion 422 and/or the third conductive portion 423) of the second housing portion 420 from the third conductive portion 433 of the third housing part 430.

For example, each of the third antenna A3 and the sixth antenna A3-1 may be configured to operate in a specific frequency band in a mid band of approximately 1.0 GHz or more and 2.3 GHz or less and/or may be configured to operate in a specific frequency band in a high band of approximately 2.3 GHz or more. For example, the second switching circuitry 460 may electrically connect the second conductive portion 422 and the third conductive portion 423 of the second housing part 420 through a filter circuit (e.g., a band-stop filter) (e.g., the second filter circuit 462 and/or the fourth filter circuit 464) configured to cut off a frequency band of approximately 2.0 GHz when the third antenna A3 and/or the sixth antenna A3-1 operate.

Accordingly, the current flowing through the housing part operating as the antenna may be reduced and/or prevented from being induced to a neighboring housing part. For example, when the third antenna A3 and/or the sixth antenna A3-1 operate, as illustrated in FIG. 10B, a current (the block 10B2) induced to the first conductive portion 421, the second conductive portion 422, and the third conductive portion 423 of the second housing part 420 from the third conductive portion 413 of the first housing part 410 and/or the third conductive portion 433 of the third housing part 430 of the electronic device 400 according to an embodiment including the second switching circuitry 460 may be reduced than a current (the block 10B1) induced to the first conductive portion 421, the second conductive portion 422, and the third conductive portion 423 of the second housing part 420 from the third conductive portion 413 of the first housing part 410 of the electronic device according to the comparative example not including the second switching circuitry 460.

Accordingly, performance of the third antenna A3 and the sixth antenna A3-1 may be improved. For example, as illustrated in FIG. 10C, total radiation efficiency (the graph 10C2) of the third antenna A3 of the electronic device 400 according to an embodiment including the second switching circuitry 460 may be improved (e.g., in a mid band and a high band) than total radiation efficiency (the graph 10C1) of the third antenna A3 of the electronic device according to the comparative example not including the second switching circuitry 460. For example, as illustrated in FIG. 10D, total radiation efficiency (the graph 10D2) of the sixth antenna A3-1 of the electronic device 400 according to an embodiment including the second switching circuitry 460 may be improved (e.g., in a mid band and a high band) than total radiation efficiency (the graph 10D1) of the sixth antenna A3-1 of the electronic device according to the comparative example not including the second switching circuitry 460.

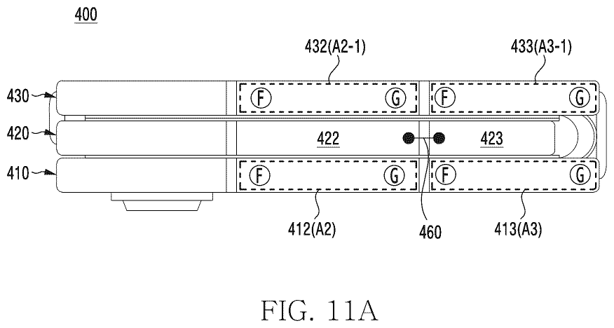

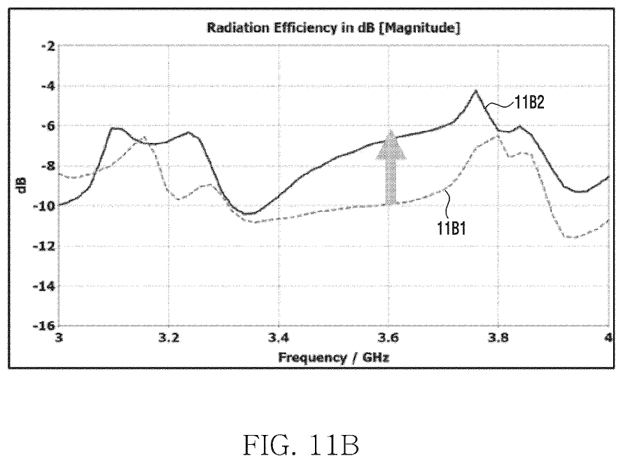

FIG. 11A indicates an electronic device in a multi-folded state according to an embodiment of the disclosure. FIG. 11B indicates radiation efficiency of a second antenna of an electronic device according to a comparative example and radiation efficiency of a second antenna of an electronic device according to a comparative example according to an embodiment of the disclosure.

A graph 11B1 of FIG. 11B indicates total radiation efficiency of a second antenna A2 of the electronic device according to a comparative example not including second switching circuitry 460, and a graph 11B2 of FIG. 11B indicates total radiation efficiency of the second antenna A2 of an electronic device 400 according to an embodiment including the second switching circuitry 460.

Referring to FIG. 11A, in a multi-folded state of the electronic device 400, a second conductive portion 412 of a first housing part 410 may operate as the second antenna A2, a third conductive portion 413 of the first housing part 410 may operate as a third antenna A3, a second conductive portion 432 of a third housing part 430 may operate as a fifth antenna A2-1, and a third conductive portion 433 of the third housing part 430 may operate as a sixth antenna A3-1.

The second switching circuitry 460 may include one or more filter circuits (e.g., at least one of filter circuits 461, 462, 463, and 464) configured to reduce and/or block an induced current caused by this, when at least one of the second antenna A2, the third antenna A3, the fifth antenna A2-1, and the sixth antenna A3-1 operates. The second switching circuitry 460 may electrically connect a second conductive portion 422 and a third conductive portion 423 of a second housing part 420 through the one or more filter circuits, selectively, according to an operating antenna.

For example, when the fifth antenna A2-1 operates in a specific frequency band of approximately 1.5 GHz or less, the second switching circuitry 460 may electrically connect the second conductive portion 422 and the third conductive portion 423 of the second housing part 420 through a filter circuit (e.g., a high-pass filter) (e.g., the third filter circuit 463) configured to cut off the frequency band of approximately 1.5 GHz or less. Accordingly, performance of the fifth antenna A2-1 may be improved (e.g., the graph 9C2 of FIG. 9C).

For example, as described with reference to FIGS. 10A, 10B, 10C, and 10D, the second switching circuitry 460 may electrically connect the second conductive portion 422 and the third conductive portion 423 of the second housing part 420 through a filter circuit (e.g., a band-stop filter) (e.g., the second filter circuit 462 and/or the fourth filter circuit 464) configured to cut off a frequency band of approximately 2.0 GHz, when the third antenna A3 and/or the sixth antenna A3-1 operate in a specific frequency band in a mid band of approximately 1.0 GHz or more and/or 2.3 GHz or less, and/or a specific frequency band in a high band of approximately 2.3 GHz or more. Accordingly, performance of the third antenna A3 and the sixth antenna A3-1 may be improved (e.g., the graph 10C2 of FIG. 10C and the graph 10D2 of FIG. 10D).

For example, the second antenna A2 may operate in a specific frequency band (e.g., a specific frequency band in a new radio frequency 1 (NR FR1) of 7.125 GHz or less) of approximately 2.7 GHz or more, and the second switching circuitry 460 may electrically connect the second conductive portion 422 and the third conductive portion 423 of the second housing part 420 through a filter circuit (e.g., the high-pass filter) (e.g., the first filter circuit 461) configured to cut off the frequency band of approximately 2.7 GHz or less when the second antenna A2 operates. Accordingly, when the second antenna A2 operates, a current of the second antenna A2 may be reduced and/or prevented from being induced to the second housing part 420 from the first housing part 410. Accordingly, performance of the second antenna A2 may be improved. For example, as illustrated in FIG. 11B, total radiation efficiency (the graph 11B2) of the second antenna A2 of the electronic device 400 according to an embodiment including the second switching circuitry 460 may be improved (e.g., in the NR FR1) than the total radiation efficiency (graph 11B1) of the second antenna A2 of the electronic device according to the comparative example not including the second switching circuitry 460.

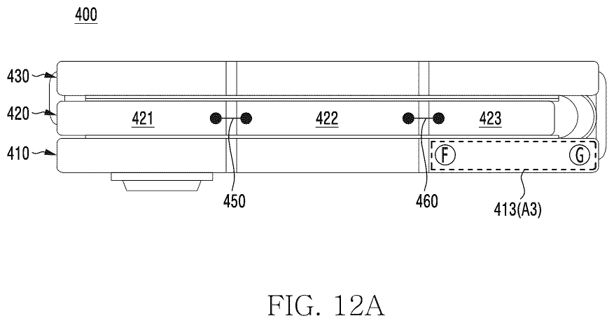

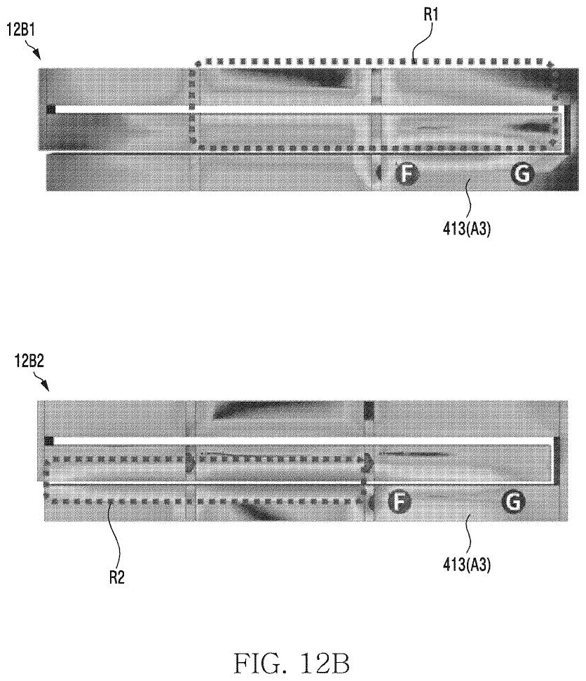

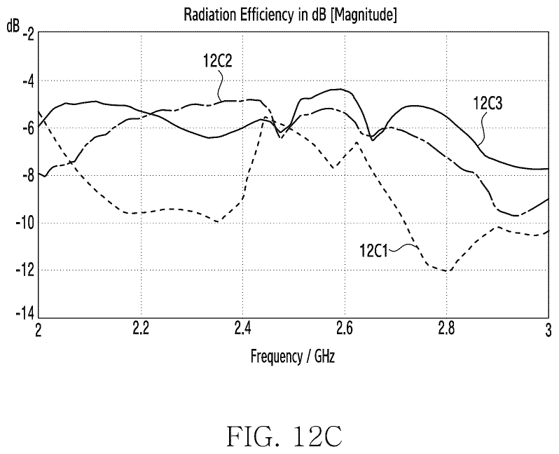

FIG. 12A indicates an electronic device in a multi-folded state according to an embodiment of the disclosure. FIG. 12B indicates a power flow during operation of a third antenna of an electronic device according to a comparative example and a power flow during operation of a third antenna of an electronic device according to an embodiment of the disclosure. FIG. 12C is a graph indicating radiation efficiency of a third antenna of an electronic device according to a comparative example and radiation efficiency of a third antenna of an electronic device according to an embodiment of the disclosure.

12B1 of FIG. 12B indicates a power flow during operation of a third antenna A3 of the electronic device of a comparative example not including first switching circuitry 450 and second switching circuitry 460, and 12B2 of FIG. 12B indicates a power flow during operation of the third antenna A3 of an electronic device 400 according to an embodiment of the disclosure, in case that a first conductive portion 421 and a second conductive portion 422 of a second housing part 420 are electrically connected through the first switching circuitry 450 and the second conductive portion 422 and the third conductive portion 423 of the second housing part 420 are electrically connected through the second switching circuitry 460.

Referring to FIG. 12A, according to an embodiment of the disclosure, in the multi-folded state of the electronic device 400, a third conductive portion 413 of a first housing part 410 may operate as the third antenna A3. When the third antenna A3 operates, the second switching circuitry 460 may electrically connect the second conductive portion 422 and the third conductive portion 423 of the second housing part 420 through a specific filter circuit (e.g., the second filter circuit 462) to reduce and/or block a current of the third antenna A3 from being induced to the second conductive portion 422 and the third conductive portion 423 of the second housing part 420.

Since the first conductive portion 421 and the second conductive portion 422 of the second housing part 420 may also be a path of an induced current, the first switching circuitry 450 may electrically connect the first conductive portion 421 and the second conductive portion 422 of the second housing part 420 through the specific filter circuit when the third antenna A3 operates.

For example, in case that the third antenna A3 operates in a specific frequency band in a mid band of 1 GHz to 2.3 GHz and/or a specific frequency band in a high band of 2.3 GHz or more, the second switching circuitry 460 may electrically connect the second conductive portion 422 and the third conductive portion 423 of the second housing part 420 through a filter circuit configured to cut off a frequency band of approximately 2 GHz, and additionally, the first switching circuitry 450 may electrically connect the first conductive portion 421 and the second conductive portion 422 of the second housing part 420 through the filter circuit configured to cut off the frequency band of approximately 2 GHz.

When the third antenna A3 operates, performance of the third antenna A3 may be improved by the second conductive portion 422 and the third conductive portion 423 of the second housing part 420 being electrically connected through the second switching circuitry 460, and the first conductive portion 421 and the second conductive portion 422 of the second housing part 420 being additionally electrically connected through the first switching circuitry 450. For example, referring to 12B1 of FIG. 12B, as indicated in a region R1, when the third antenna A3 operates, an amount of power coupled to a neighboring housing part may be increased. On the other hand, referring to 12B2 of FIG. 12B, as indicated in a region R2, radiation contribution of the first housing part 410 corresponding to the third antenna A3 may be improved by conductive portions of the second housing part 420 being connected through the first switching circuitry 450 and the second switching circuitry 460.

Referring to FIG. 12C together with FIG. 12A, a graph 12C1 indicates radiation efficiency of the third antenna A3 of the electronic device according to a comparative example not including the first switching circuitry 450 and the second switching circuitry 460.

A graph 12C2 indicates radiation efficiency of the third antenna A3, in case that the second conductive portion 422 and the third conductive portion 423 of the second housing part 420 are electrically connected through the second switching circuitry 460, and the first conductive portion 421 and the second conductive portion 422 of the second housing part 420 are not electrically connected through the first switching circuitry 450.

A graph 12C3 indicates radiation efficiency of the third antenna A3, in case that the second conductive portion 422 and the third conductive portion 423 of the second housing part 420 are electrically connected through the second switching circuitry 460, and the first conductive portion 421 and the second conductive portion 422 of the second housing part 420 are electrically connected through the first switching circuitry 450.

Comparing the graph 12C1 with the graph 12C2, the radiation efficiency of the third antenna A3 may be improved by the second conductive portion 422 and the third conductive portion 423 of the second housing part 420 being electrically connected through the second switching circuitry 460. In addition, comparing the graph 12C2 with the graph 12C3, the radiation efficiency of the third antenna A3 may be improved (e.g., at a frequency of approximately 2.45 GHz or more) by the first conductive portion 421 and the second conductive portion 422 of the second housing part 420 being additionally electrically connected through the first switching circuitry 450.

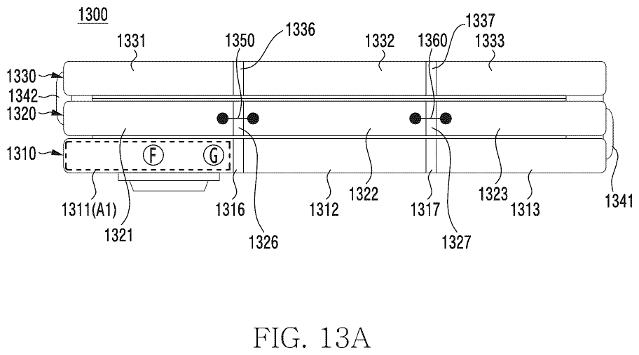

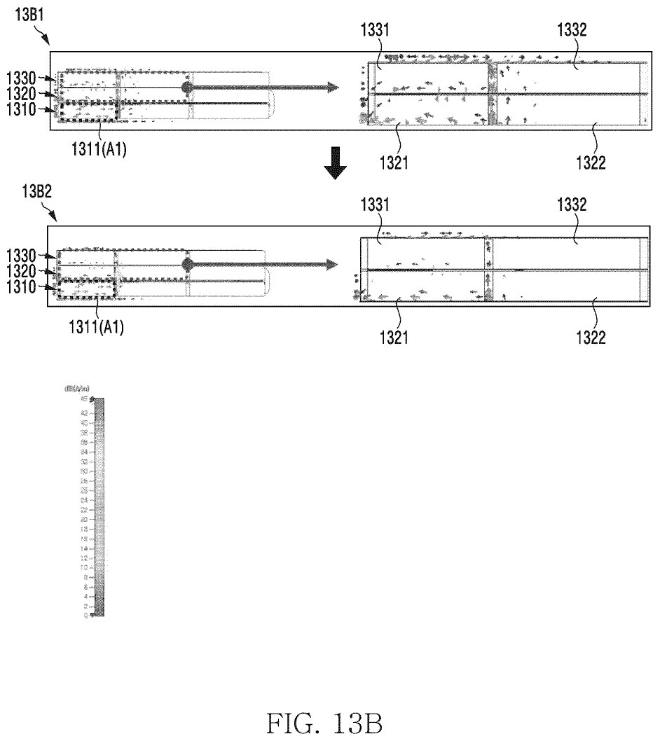

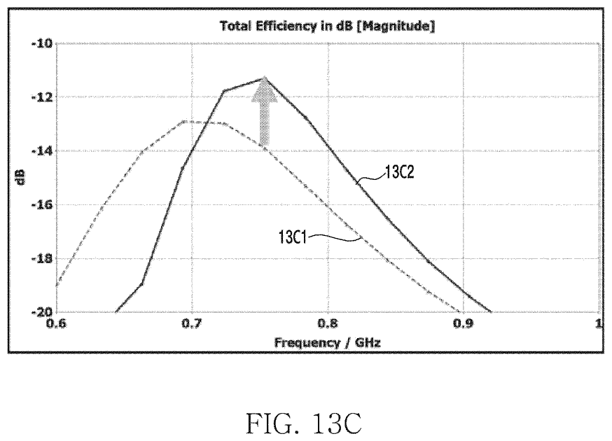

FIG. 13A indicates an electronic device in a multi-folded state according to an embodiment of the disclosure. FIG. 13B indicates a current flow during operation of a first antenna of an electronic device according to a comparative example and a current flow during operation of a first antenna of an electronic device according to an embodiment of the disclosure. FIG. 13C indicates radiation efficiency of a first antenna of an electronic device according to a comparative example and radiation efficiency of a first antenna of an electronic device according to an embodiment of the disclosure.

A block 13B1 of FIG. 13B indicates a current flow during operation of a first antenna A1 of the electronic device according to a comparative example not including first switching circuitry (or circuit) 1350 and second switching circuitry (or circuit) 1360.

A block 13B2 of FIG. 13B indicates a current flow during operation of the first antenna A1 of an electronic device 1300 according to an embodiment of the disclosure, in case that a first conductive portion 1321 and a second conductive portion 1322 of a second housing part 1320 are electrically connected through the first switching circuitry 1350.

A graph 13C1 of FIG. 13C indicates radiation efficiency of the first antenna A1 of the electronic device according to a comparative example not including the first switching circuitry 1350 and the second switching circuitry 1360.

A graph 13C2 of FIG. 13C indicates radiation efficiency of the first antenna A1 of the electronic device 1300 according to an embodiment of the disclosure, in case that the first conductive portion 1321 and the second conductive portion 1322 of the second housing part 1320 are electrically connected through the first switching circuitry 1350.

Referring to previous drawings, it has been described that each of a first housing part 410 and a second housing part 420 of an electronic device 400 is rotatably connected to a third housing part 430, but is not limited thereto. For example, referring to FIG. 13A, according to an embodiment of the disclosure, the electronic device 1300 may include a first housing part 1310, the second housing part 1320 rotatably coupled to the first housing part 1310, and a third housing part 1330 rotatably coupled to the second housing part 1320. In the multi-folded state of the electronic device 1300, the second housing part 1320 may be placed on the first housing part 1310, and the third housing part 1330 may be placed on the second housing part 1320. The electronic device 1300 may include a first hinge structure 1341 rotatably connecting the first housing part 1310 and the second housing part 1320, and a second hinge structure 1342 rotatably connecting the second housing part 1320 and the third housing part 1330.

For the first housing part 1310 of the electronic device 1300, a description of the first housing part 410 of the electronic device 400 may be applied substantially identically, similarly, or in a corresponding manner, except that the first housing part 1310 is connected to the second housing part 1320 rather than the third housing part 1330. For example, the first housing part 1310 of the electronic device 1300 may include a first conductive portion 1311 (e.g., the first conductive portion 411), a second conductive portion 1312 (e.g., the second conductive portion 412), a third conductive portion 1313 (e.g., the third conductive portion 413), a first non-conductive portion 1316 (e.g., the first non-conductive portion 416), and a second non-conductive portion 1317 (e.g., the second non-conductive portion 417).

For the second housing part 1320 of the electronic device 1300, a description of the second housing part 420 of the electronic device 400 may be applied substantially identically, similarly, or in a corresponding manner, except that the second housing part 1320 is connected to the first housing part 1310 and the third housing part 1330 as well as the third housing part 1330. For example, the second housing part 1320 of the electronic device 1300 may include a first conductive portion 1321 (e.g., the first conductive portion 421), a second conductive portion 1322 (e.g., the second conductive portion 422), a third conductive portion 1323 (e.g., the third conductive portion 423), a first non-conductive portion 1326 (e.g., the first non-conductive portion 426), and a second non-conductive portion 1327 (e.g., the second non-conductive portion 427).

For the third housing part 1330 of the electronic device 1300, a description of the second housing part 430 of the electronic device 400 may be applied substantially identically, similarly, or in a corresponding manner, except that the third housing part 1330 is connected only to the second housing part 1320 rather than the first housing part 1310 and the second housing part 1320. For example, the third housing part 1330 of the electronic device 1300 may include a first conductive portion 1331 (e.g., the first conductive portion 431), a second conductive portion 1332 (e.g., the second conductive portion 432), a third conductive portion 1333 (e.g., the third conductive portion 433), a first non-conductive portion 1336 (e.g., the first non-conductive portion 436), and a second non-conductive portion 1337 (e.g., the second non-conductive portion 437).

According to an embodiment of the disclosure, the electronic device 1300 may include the first switching circuitry 1350 and the second switching circuitry 1360. For the first switching circuitry 1350 and the second switching circuitry 1360, a description of the first switching circuitry 450 and the second switching circuitry 460 described above may be applied substantially identically, similarly, or in a corresponding manner. For example, when the first conductive portion 1311 of the first housing part 1310 operates as the first antenna A1 in the multi-folded state of the electronic device 1300, the first switching circuitry 1350 may be configured to reduce and/or block a current of the first antenna A1 from being induced to the conductive portions 1321, 1322, and 1323 of the second housing part 1320 adjacent to the first housing part 1310. For example, in case that the first antenna A1 operates in a specific frequency band in a low band of 1 GHz or less, the first switching circuitry 1350 may electrically connect the first conductive portion 1321 and the second conductive portion 1322 of the second housing part 1320 through a filter circuit (e.g., a band stop circuit) (e.g., the first filter circuit 451) configured to cut off a frequency of approximately 1 GHz. Accordingly, referring to FIG. 13B, in comparison with an amount (the block 13B1) of a current induced to the second housing part 1320 and the third housing part 1330 of the electronic device in a comparative example not including the first switching circuitry 1350 and the second switching circuitry 1360 when the first antenna A1 operates, when the first conductive portion 1321 and the second conductive portion 1322 of the second housing part 1320 are electrically connected through the first switching circuitry 1350, an amount (the block 13B2) of a current induced to the second housing part 1320 and the third housing part 1330 may be reduced when the first antenna A1 operates. In addition, referring to FIG. 13C, radiation efficiency (the graph 13C2) of the first antenna A1 of the electronic device 1300 according to an embodiment in which the first conductive portion 1321 and the second conductive portion 1322 of the second housing part 1320 are electrically connected through the first switching circuitry 1350 may be improved, compared to radiation efficiency (the graph 13C1) of the first antenna A1 of the electronic device in the comparative example not including the first switching circuitry 1350 and the second switching circuitry 1360.

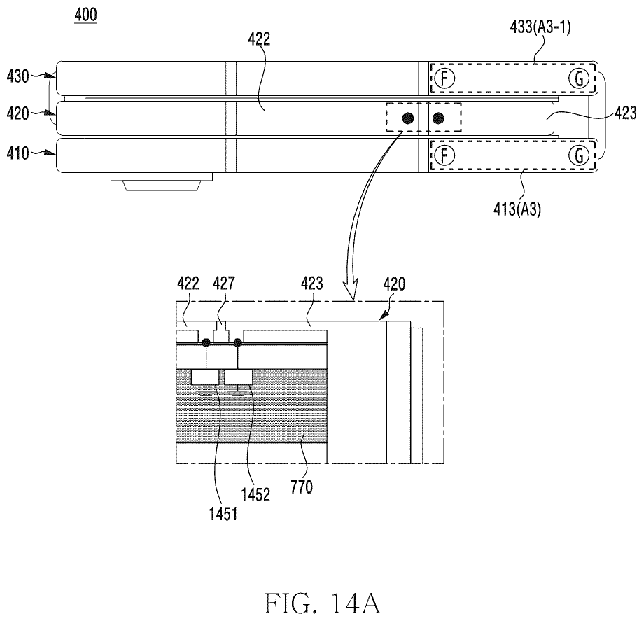

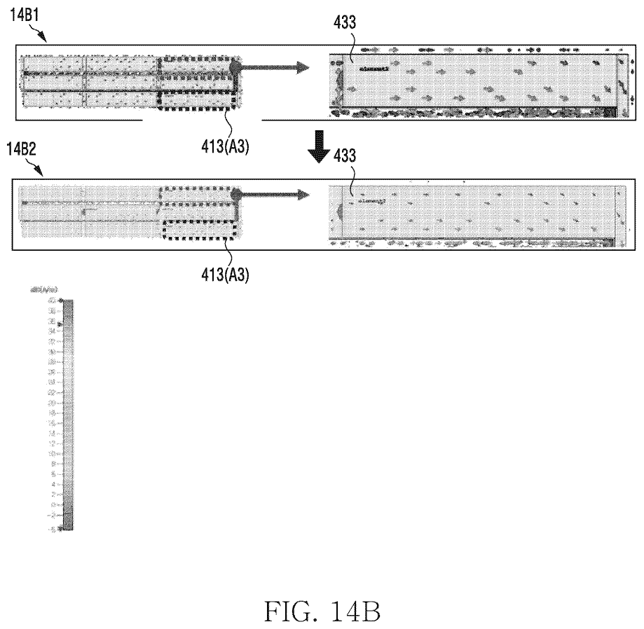

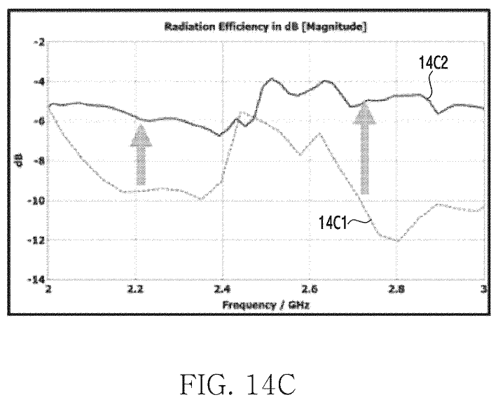

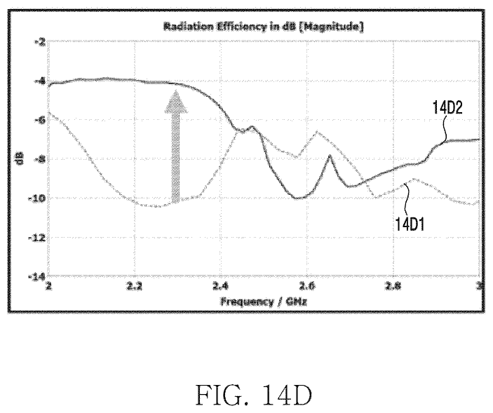

FIG. 14A indicates an electronic device in a multi-folded state according to an embodiment of the disclosure. FIG. 14B indicates a current flow during operation of a third antenna of an electronic device according to a comparative example and a current flow during operation of a third antenna of an electronic device according to an embodiment of the disclosure. FIG. 14C indicates radiation efficiency of a third antenna of an electronic device according to a comparative example and radiation efficiency of a third antenna of an electronic device according to an embodiment of the disclosure. FIG. 14D indicates radiation efficiency of a sixth antenna of an electronic device according to a comparative example and radiation efficiency of a sixth antenna of an electronic device according to an embodiment of the disclosure.

A block 14B1 of FIG. 14B indicates a current flow during operation of a third antenna A3 of the electronic device according to a comparative example not including first switching circuitry (or circuit) 1451 and second switching circuitry (or circuit) 1452.

A block 14B2 of FIG. 14B indicates a current flow during operation of a third antenna A3 of an electronic device 400 according to an embodiment of the disclosure, in case that a second conductive portion 422 and a third conductive portion 423 of a second housing part 420 are respectively grounded through the first switching circuitry 1451 and the second switching circuitry 1452.

A graph 14C1 of FIG. 14C indicates radiation efficiency of the third antenna A3 of the electronic device according to a comparative example not including the first switching circuitry 1451 and the second switching circuitry 1452.

A graph 14C2 of FIG. 14C indicates radiation efficiency of the third antenna A3 of the electronic device 400 according to an embodiment of the disclosure, in case that the second conductive portion 422 and the third conductive portion 423 of the second housing part 420 are respectively grounded through the first switching circuitry 1451 and the second switching circuitry 1452.

A graph 14D1 of FIG. 14D indicates radiation efficiency of a sixth antenna A3-1 of the electronic device according to the comparative example not including the first switching circuitry 1451 and the second switching circuitry 1452.

A graph 14D2 of FIG. 14D indicates radiation efficiency of the sixth antenna A3-1 of the electronic device 400 according to an embodiment of the disclosure, in case that the second conductive portion 422 and the third conductive portion 423 of the second housing part 420 are respectively grounded through the first switching circuitry 1451 and the second switching circuitry 1452.

Referring to FIG. 14A, the electronic device 400 according to an embodiment may include the first switching circuitry 1451 and the second switching circuitry 1452 instead of the second switching circuitry 460 described above.

The first switching circuitry 1451 may be an example configuration in which the above-described second switching circuitry 460 is electrically connected to ground (e.g., a conductive region of a printed circuit board 770 operating as at least a portion of the ground) of the electronic device 400 rather than the third conductive portion 423 of the second housing part 420.

The second switching circuitry 1452 may be an example configuration in which the above-described second switching circuitry 460 is electrically connected to the ground of the electronic device 400 rather than the second conductive portion 422 of the second housing part 420.

For example, when the third antenna A3 and/or the sixth antenna A3-1 operate, the first switching circuitry 1451 may electrically connect the second conductive portion 422 of the second housing part 420 to a specific filter circuit (e.g., a band pass filter configured to cut off a frequency band of approximately 2 GHz to approximately 3 GHz) connected to the ground. For example, when the third antenna A3 and/or the sixth antenna A3-1 operate, the first switching circuitry 1451 may electrically connect the second conductive portion 422 of the second housing part 420 and the ground through the specific filter circuit (e.g., the band pass filter configured to cut off the frequency band of approximately 2 GHz to approximately 3 GHz).

For example, when the third antenna A3 and/or the sixth antenna A3-1 operate, the second switching circuitry 1452 may electrically connect the third conductive portion 423 of the second housing part 420 to a specific filter circuit (e.g., the band pass filter configured to cut off the frequency band of approximately 2 GHz to approximately 3 GHz) connected to the ground. When the third antenna A3 and/or the sixth antenna A3-1 operate, the second switching circuitry 1452 may electrically connect the third conductive portion 423 of the second housing part 420 and the ground through the specific filter circuit (e.g., the band pass filter configured to cut off the frequency band of approximately 2 GHz to approximately 3 GHz).

Accordingly, referring to FIG. 14B, when the third antenna A3 of the electronic device of the comparative example not including the first switching circuitry 1451 and the second switching circuitry 1452 operates, in comparison with the amount (the block 14B1) of a current to a third conductive portion 433 of a third housing part 430, when the third antenna A3 of the electronic device 400 according to an embodiment operates, an amount (the block 14B2) of a current induced to the third conductive portion 433 of the third housing part 430 may be reduced by electrically connecting the second conductive portion 422 and the third conductive portion 423 of the second housing part 420 respectively to the ground through the first switching circuitry 1451 and the second switching circuitry 1452.

In addition, referring to FIG. 14C, radiation efficiency (the graph 14C2) of the third antenna A3 of the electronic device 400 according to an embodiment in which the second conductive portion 422 and the third conductive portion 423 of the second housing part 420 are electrically connected respectively to the ground through the first switching circuitry 1451 and the second switching circuitry 1452 may be improved, compared to radiation efficiency (the graph 14C1) of the third antenna A3 of the electronic device in the comparative example not including the first switching circuitry 1451 and the second switching circuitry 1452.

In addition, referring to FIG. 14D, radiation efficiency (the graph 14D2) of the sixth antenna A3-1 of the electronic device 400 according to an embodiment in which the second conductive portion 422 and the third conductive portion 423 of the second housing part 420 are electrically connected respectively to the ground through the first switching circuitry 1451 and the second switching circuitry 1452 may be improved, compared to radiation efficiency (the graph 14D1) of the sixth antenna A3-1 of the electronic device in the comparative example not including the first switching circuitry 1451 and the second switching circuitry 1452.

A technical task to be achieved from the disclosure are not limited to those described above, and any other technical tasks not mentioned herein will be clearly understood by those having ordinary knowledge in the art to which the disclosure belongs.

According to an embodiment of the disclosure, an electronic device 400 may comprise a foldable housing including a first housing part 410, a second housing part 420, and a third housing part 430. Each of the first housing part 410, the second housing part 420, and the third housing part 430 may be rotatably coupled to an adjacent housing part among the first housing part 410, the second housing part 420, and the third housing part 430 so as to allow the foldable housing to transition between a folded state and an unfolded state. In the unfolded state, the first housing part 410, the second housing part 420, and the third housing part 430 may be positioned on substantially the same plane. In the folded state, the second housing part 420 may be positioned on the first housing part 410. In the folded state, the third housing part 430 may be positioned on the second housing part 420. The first housing part 410 may include a first conductive portion 411 or 413 configured to operate as an antenna radiator A1 or A3 of the electronic device 400, a second conductive portion 412 spaced apart from the first conductive portion 411 or 413, and a first non-conductive portion 416 or 417 disposed between the first conductive portion 411 or 413 and the second conductive portion 412. The second housing part 420 may include a third conductive portion 421 or 423, a fourth conductive portion 422 spaced apart from the third conductive portion 421 or 423, and a second non-conductive portion 426 or 427 disposed between the third conductive portion 421 or 423 and the fourth conductive portion 422. In the folded state, the first conductive portion 411 or 413 of the first housing part 410 may at least partially face the third conductive portion 421 or 423 of the second housing part 420. The electronic device 400 may comprise switching circuitry 450 or 460 electrically connected to the third conductive portion 421 or 423 and the fourth conductive portion 422 of the second housing part 420. While the first conductive portion 411 or 413 of the first housing part 410 operates as the antenna radiator A1 or A3 in the folded state, the switching circuitry 450 or 460 may be configured to filter a signal having a frequency corresponding to an operating frequency of the antenna radiator A1 or A3.

In an embodiment of the disclosure, the switching circuitry 450 or 460 may be configured to reduce a signal corresponding to the operating frequency from being induced to the third conductive portion 421 or 423 of the second housing part 420 from the first conductive portion 411 or 413 of the first housing part 410.

In an embodiment of the disclosure, the switching circuitry 450 or 460 may include one or more lumped elements configured to reduce the signal corresponding the operating frequency from being induced to the third conductive portion 421 or 423 of the second housing part 420 from the first conductive portion 411 or 413 of the first housing part 410.

In an embodiment of the disclosure, the antenna radiator A1 or A3 may be a first antenna radiator A1 or A3 having a first operating frequency. The signal having the frequency corresponding to the first operating frequency of the first antenna radiator A1 or A3 may be a first signal. The second conductive portion 412 of the first housing part 410 may be configured to operate as a second antenna radiator A2 of the electronic device 400 at a second operating frequency. The switching circuitry 450 or 460 may be configured to filter a second signal corresponding to the second operating frequency of the second antenna radiator A2 while the second conductive portion 412 of the first housing part 410 operates as the second antenna radiator A2 in the folded state.

In an embodiment of the disclosure, the operating frequency of the antenna radiator A1 or A3 using the first conductive portion 411 or 413 may include a first operating frequency and a second operating frequency different from the first operating frequency. The switching circuitry 450 or 460 may be configured to filter a second signal having a frequency corresponding to the second operating frequency while the antenna radiator A1 or A3 operates at the second operating frequency in the folded state.

In an embodiment of the disclosure, the switching circuitry 450 or 460 may comprise a first LC filter circuit configured to filter the first signal, and a second LC filter circuit configured to filter the second signal.

In an embodiment of the disclosure, the third housing part 430 may include a fifth conductive portion 431 or 433 configured to operate as a third antenna radiator A1-1 or A3-1 of the electronic device 400 at a third operating frequency, a sixth conductive portion 432 spaced apart from the fifth conductive portion 431 or 433, and a third non-conductive portion 436 or 437 disposed between the fifth conductive portion 431 or 433 and the sixth conductive portion 432. The fifth conductive portion 431 or 433 of the third housing part 430, in the folded state, may at least partially face the third conductive portion 421 or 423 of the second housing part 420. The switching circuitry 450 or 460 may be configured to filter a third signal having a frequency corresponding to the third operating frequency of the third antenna radiator A1-1 or A3-1 while the fifth conductive portion 431 or 433 of the third housing part 430 operates as the third antenna radiator A1-1 or A3-1 in the folded state.

In an embodiment of the disclosure, the sixth conductive portion 432 of the third housing part 430 may be configured to operate as a fourth antenna radiator A2-1 of the electronic device 400 at a fourth operating frequency. The switching circuitry 450 or 460 may be configured to filter a fourth signal corresponding to the fourth operating frequency of the fourth antenna radiator A2-1 while the sixth conductive portion 432 of the third housing part 430 operates as the fourth antenna radiator A2-1 in the folded state.

In an embodiment of the disclosure, the switching circuitry 450 or 460 may comprise a third LC filter circuit 453 or 463 configured to filter the third signal, and a fourth LC filter circuit 454 or 464 configured to filter the fourth signal.

In an embodiment of the disclosure, the switching circuitry 450 or 460 may be configured to pass a signal corresponding to a second frequency band from among a first frequency band including the operating frequency and the second frequency band not including the operating frequency.

In an embodiment of the disclosure, the second non-conductive portion 426 or 427 of the second housing part 420 may extend from an end of the third conductive portion 421 or 423 to an end of the fourth conductive portion 422. The switching circuitry 450 or 460 may be electrically connected to the end of the third conductive portion 421 or 423 and the end of the fourth conductive portion 422.

In an embodiment of the disclosure, the switching circuitry 450 or 460 may be first switching circuitry 450. The first housing part 410 may include a seventh conductive portion 413 spaced apart from the second conductive portion 412, and a fourth non-conductive portion 417 disposed between the second conductive portion 412 and the seventh conductive portion 413. The second housing part 420 may include an eighth conductive portion 423 spaced apart from the fourth conductive portion 422, and a fifth non-conductive portion 427 disposed between the fourth conductive portion 422 and the eighth conductive portion 423. The electronic device 400 may comprise second switching circuitry 460 electrically connected to the fourth conductive portion 422 and the eighth conductive portion 423.

In an embodiment of the disclosure, the second switching circuitry 460 may be configured to filter the signal having the frequency corresponding to the operating frequency of the antenna radiator A1 while the first conductive portion 411 of the first housing part 410 operates as the antenna radiator A1 in the folded state.

In an embodiment of the disclosure, the antenna radiator A1 or A3 may be a first antenna radiator A1. The second conductive portion 412 of the first housing part 410 may be configured to operate as a second antenna radiator A2 of the electronic device 400 at a second operating frequency. The second switching circuitry 460 may be configured to filter a signal having a frequency corresponding to the second operating frequency of the second antenna radiator A2 while the second conductive portion 412 of the first housing part 410 operates as the second antenna radiator A2 in the folded state.

In an embodiment of the disclosure, the first housing part 410 may be rotatably coupled to a first side portion of the third housing part 430. The second housing part 420 may be rotatably coupled to a second side portion of the third housing part 430, opposite to the first side portion.

In an embodiment of the disclosure, the first housing part 410 may be rotatably coupled to a first side portion of the second housing part 420. The third housing part 430 may be rotatably coupled to a second side portion of the second housing part 420, opposite to the first side portion.

According to an embodiment of the disclosure, a foldable electronic device 400 may comprise a first housing part 410, a second housing part 420, and a third housing part 430. The first housing part 410 may be rotatably coupled to a first side of the third housing part 430 and the second housing part 420 may be rotatably coupled to a second side of the third housing part 430. In an unfolded state of the electronic device 400, the first housing part 410, the second housing part 420, and the third housing part 430 may be positioned on substantially the same plane. In a folded state of the electronic device 400, the second housing part 420 may be positioned on the first housing part 410. The third housing part 430 may be positioned on the second housing part 420. The first housing part 410 may include a first conductive portion 411 or 413 configured to operate as an antenna radiator A1 or A3 of the electronic device 400, a second conductive portion 412 spaced apart from the first conductive portion 411 or 413, and a first non-conductive portion 416 or 417 disposed between the first conductive portion 411 or 413 and the second conductive portion 412. The second housing part 420 may include a third conductive portion 421 or 423, a fourth conductive portion 422 spaced apart from the third conductive portion 421 or 423, and a second non-conductive portion 426 or 427 disposed between the third conductive portion 421 or 423 and the fourth conductive portion 422. In the folded state, the first conductive portion 411 or 413 of the first housing part 410 may at least partially face the second conductive portion 412 of the second housing part 420. The foldable electronic device 400 may comprise switching circuitry 450 or 460 electrically connected to the third conductive portion 421 or 423 and the fourth conductive portion 422 of the second housing part 420. While the first conductive portion 411 or 413 of the first housing part 410 operates as the antenna radiator A1 or A3 in the folded state, the switching circuitry 450 or 460 may be configured to filter a signal having a frequency corresponding to an operating frequency of the antenna radiator A1 or A3.

In an embodiment of the disclosure, the switching circuitry 450 or 460 may be configured to reduce a signal corresponding to the operating frequency from being induced to the third conductive portion 421 or 423 of the second housing part 420 from the first conductive portion 411 or 413 of the first housing part 410.

In an embodiment of the disclosure, the switching circuitry 450 or 460 may include one or more lumped elements configured to reduce the signal corresponding the operating frequency from being induced to the third conductive portion 421 or 423 of the second housing part 420 from the first conductive portion 411 or 413 of the first housing part 410.

In an embodiment of the disclosure, the antenna radiator A1 or A3 may be a first antenna radiator A1 or A3 having a first operating frequency. The second conductive portion 412 of the first housing part 410 may be configured to operate as a second antenna radiator A2 of the electronic device 400 at a second operating frequency. The switching circuitry 450 or 460 may be configured to filter a second signal corresponding to the second operating frequency of the second antenna radiator A2 while the second conductive portion 412 of the first housing part 410 operates as the second antenna radiator A2 in the folded state.

The effects that may be obtained from the disclosure are not limited to those described above, and any other effects not mentioned herein will be clearly understood by those having ordinary knowledge in the art to which the disclosure belongs.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a foldable housing including:
a first housing part,
a second housing part, and
a third housing part,
wherein each of the first housing part, the second housing part, and the third housing part is rotatably coupled to an adjacent housing part among the first housing part, the second housing part, and the third housing part so as to allow the foldable housing to transition between a folded state and an unfolded state,
wherein, in the unfolded state, the first housing part, the second housing part, and the third housing part are positioned on substantially the same plane,
wherein, in the folded state, the second housing part is positioned on the first housing part, and the third housing part is positioned on the second housing part,
wherein the first housing part includes:
a first conductive portion configured to operate as an antenna radiator of the electronic device,
a second conductive portion spaced apart from the first conductive portion, and
a first non-conductive portion disposed between the first conductive portion and the second conductive portion,
wherein the second housing part includes:
a third conductive portion,
a fourth conductive portion spaced apart from the third conductive portion, and
a second non-conductive portion disposed between the third conductive portion and the fourth conductive portion,
wherein, in the folded state, the first conductive portion of the first housing part at least partially faces the third conductive portion of the second housing part,
wherein the electronic device comprises switching circuitry electrically connected to the third conductive portion and the fourth conductive portion of the second housing part, and
wherein, while the first conductive portion of the first housing part operates as the antenna radiator in the folded state, the switching circuitry is configured to filter a signal having a frequency corresponding to an operating frequency of the antenna radiator.

2. The electronic device of claim 1, wherein the switching circuitry is configured to reduce a signal corresponding to the operating frequency from being induced to the third conductive portion of the second housing part from the first conductive portion of the first housing part.

3. The electronic device of claim 2, wherein the switching circuitry includes one or more lumped elements configured to reduce the signal corresponding the operating frequency from being induced to the third conductive portion of the second housing part from the first conductive portion of the first housing part.

4. The electronic device of claim 1,
wherein the antenna radiator is a first antenna radiator having a first operating frequency,
wherein the signal having the frequency corresponding to the first operating frequency of the first antenna radiator is a first signal,
wherein the second conductive portion of the first housing part is configured to operate as a second antenna radiator of the electronic device at a second operating frequency, and
wherein the switching circuitry is configured to filter a second signal corresponding to the second operating frequency of the second antenna radiator while the second conductive portion of the first housing part operates as the second antenna radiator in the folded state.

5. The electronic device of claim 1,
wherein the operating frequency of the antenna radiator using the first conductive portion includes:
a first operating frequency, and
a second operating frequency different from the first operating frequency, and
wherein the switching circuitry is configured to filter a second signal having a frequency corresponding to the second operating frequency while the antenna radiator operates at the second operating frequency in the folded state.

6. The electronic device of claim 4, wherein the switching circuitry comprises:
a first LC filter circuit configured to filter the first signal; and
a second LC filter circuit configured to filter the second signal.

7. The electronic device of claim 6,
wherein the third housing part includes:
a fifth conductive portion configured to operate as a third antenna radiator of the electronic device at a third operating frequency,
a sixth conductive portion spaced apart from the fifth conductive portion, and
a third non-conductive portion disposed between the fifth conductive portion and the sixth conductive portion,
wherein the fifth conductive portion of the third housing part, in the folded state, at least partially faces the third conductive portion of the second housing part, and
wherein the switching circuitry is configured to filter a third signal having a frequency corresponding to the third operating frequency of the third antenna radiator while the fifth conductive portion of the third housing part operates as the third antenna radiator in the folded state.

8. The electronic device of claim 7,
wherein the sixth conductive portion of the third housing part is configured to operate as a fourth antenna radiator of the electronic device at a fourth operating frequency, and
wherein the switching circuitry is configured to filter a fourth signal corresponding to the fourth operating frequency of the fourth antenna radiator while the sixth conductive portion of the third housing part operates as the fourth antenna radiator in the folded state.

9. The electronic device of claim 8, wherein the switching circuitry comprises:
a third LC filter circuit configured to filter the third signal; and
a fourth LC filter circuit configured to filter the fourth signal.

10. The electronic device of claim 1, wherein the switching circuitry is configured to pass a signal corresponding to a second frequency band from among a first frequency band including the operating frequency and the second frequency band not including the operating frequency.

11. The electronic device of claim 1,
wherein the second non-conductive portion of the second housing part extends from an end of the third conductive portion to an end of the fourth conductive portion, and
wherein the switching circuitry is electrically connected to the end of the third conductive portion and the end of the fourth conductive portion.

12. The electronic device of claim 1,
wherein the switching circuitry is a first switching circuitry,
wherein the first housing part includes:
a seventh conductive portion spaced apart from the second conductive portion, and
a fourth non-conductive portion disposed between the second conductive portion and the seventh conductive portion,
wherein the second housing part includes:
an eighth conductive portion spaced apart from the fourth conductive portion, and
a fifth non-conductive portion disposed between the fourth conductive portion and the eighth conductive portion, and
wherein the electronic device comprises a second switching circuitry electrically connected to the fourth conductive portion and the eighth conductive portion.

13. The electronic device of claim 12, wherein the second switching circuitry is configured to filter the signal having the frequency corresponding to the operating frequency of the antenna radiator while the first conductive portion of the first housing part operates as the antenna radiator in the folded state.

14. The electronic device of claim 13,
wherein the antenna radiator is a first antenna radiator,
wherein the second conductive portion of the first housing part is configured to operate as a second antenna radiator of the electronic device at a second operating frequency, and
wherein the second switching circuitry is configured to filter a signal having a frequency corresponding to the second operating frequency of the second antenna radiator while the second conductive portion of the first housing part operates as the second antenna radiator in the folded state.

15. The electronic device of claim 1,
wherein the first housing part is rotatably coupled to a first side portion of the third housing part, and
wherein the second housing part is rotatably coupled to a second side portion of the third housing part, opposite to the first side portion.

16. The electronic device of claim 1,
wherein the first housing part is rotatably coupled to a first side portion of the second housing part, and
wherein the third housing part is rotatably coupled to a second side portion of the second housing part, opposite to the first side portion.

17. A foldable electronic device comprising:
a first housing part;
a second housing part; and
a third housing part,
wherein the first housing part is rotatably coupled to a first side of the third housing part and the second housing part is rotatably coupled to a second side of the third housing part,
wherein, in an unfolded state of an electronic device, the first housing part, the second housing part, and the third housing part are positioned on substantially the same plane,
wherein, in a folded state of the electronic device, the second housing part is positioned on the first housing part, and the third housing part is positioned on the second housing part,
wherein the first housing part includes:
a first conductive portion configured to operate as an antenna radiator of the electronic device,
a second conductive portion spaced apart from the first conductive portion, and
a first non-conductive portion disposed between the first conductive portion and the second conductive portion,
wherein the second housing part includes:
a third conductive portion,
a fourth conductive portion spaced apart from the third conductive portion, and
a second non-conductive portion disposed between the third conductive portion and the fourth conductive portion,
wherein, in the folded state, the first conductive portion of the first housing part at least partially faces the second conductive portion of the second housing part,
wherein the foldable electronic device comprises switching circuitry electrically connected to the third conductive portion and the fourth conductive portion of the second housing part, and
wherein, while the first conductive portion of the first housing part operates as the antenna radiator in the folded state, the switching circuitry is configured to filter a signal having a frequency corresponding to an operating frequency of the antenna radiator.

18. The foldable electronic device of claim 17, wherein the switching circuitry is configured to reduce a signal corresponding to the operating frequency from being induced to the third conductive portion of the second housing part from the first conductive portion of the first housing part.

19. The foldable electronic device of claim 18, wherein the switching circuitry includes one or more lumped elements configured to reduce the signal corresponding the operating frequency from being induced to the third conductive portion of the second housing part from the first conductive portion of the first housing part.

20. The foldable electronic device of claim 17,
wherein the antenna radiator is a first antenna radiator having a first operating frequency,
wherein the second conductive portion of the first housing part is configured to operate as a second antenna radiator of the electronic device at a second operating frequency, and
wherein the switching circuitry is configured to filter a second signal corresponding to the second operating frequency of the second antenna radiator while the second conductive portion of the first housing part operates as the second antenna radiator in the folded state.
